(19) United States
(12) Patent Application Publication
(10) Pub. No.: US 2015/0003606 A1
(43) Pub. Date: Jan. 1, 2015

(54) DETECTING AND QUANTIFYING NON-LINEAR CHARACTERISTICS OF AUDIO SIGNALS

(71) Applicant: Broadcom Corporation, Irvine, CA (US)

(72) Inventor: Elias Nemer, Irvine, CA (US)

(73) Assignee: Broadcom Corporation, Irvine, CA (US)

(21) Appl. No.: 13/956,031

(22) Filed: Jul. 31, 2013

Related U.S. Application Data
(60) Provisional application No. 61/841,137, filed on Jun. 28, 2013.

(51) Int. Cl. H04M 3/00

(52) U.S. Cl. CPC H04M 3/002
USPC 379/406.01

(57) ABSTRACT

Methods, systems, and apparatuses are provided for detecting, quantifying, and compensating for non-linear characteristics of audio signals. External audio devices are detected when coupled to electronic or communication devices. Tuning operations are initiated upon detection of external audio devices to estimate non-linear parameters imparted to audio signals by the external audio devices. The non-linear components of audio signals are compensated for based upon the estimations. Compensation is performed using pre-processing filters, distortion circuits, post-processing filters. Estimation and compensation for non-linearities is performed on the basis of models dynamically generated during estimation and the use of higher-order statistics.

### CROSS REFERENCE TO RELATED APPLICATION

This application claims priority to U.S. Provisional Application Ser. No. 61/841,137, filed Jun. 28, 2013, the entirety of which is incorporated by reference herein.

### BACKGROUND

1. Technical Field

The subject matter described herein relates to systems, apparatuses, and methods for detecting, quantifying, and compensating for non-linear characteristics of audio signals.

2. Background Art

Echo cancellation is used in modern telephony in a number of ways for audio signal improvement in communication devices. For example, a linear acoustic echo canceller (AEC) may be used in duplex telephony systems to eliminate the return echo to the far-end user, due to reflections or coupling between the speakers and the microphone in the near-end room. An echo canceller typically consists of a linear filter and an adaptation algorithm that adjusts the filter coefficients in a way to match the estimated echo path. The adaptation may be based on an optimality criteria such that the outgoing signal to the far-end user contains a minimum level of residual echo. Changes in the echo path in the near-end room, such as positional shifts by the persons or the devices (e.g., the phone, the microphone, the speaker, etc.) cause the adaptation to start a re-convergence process to re-adapt to the new path. Until the AEC has adapted to the new response, a substantial amount of echo may be sent to the far-end user.

A typical AEC solution is shown in FIG. 1. FIG. 1 shows a telephony system 100 with a telephony device 102 that includes an AEC 104 and a near-end room 106 with an external audio amplifier 108, an external loudspeaker 110, a microphone 112, and a near-end talker 114. AEC 104 seeks to minimize the contribution of an echo return signal y(n) from external loudspeaker 110 to the power of an error signal e(n) by subtracting an estimate of the echo signal y′(n) from the signal d(n) of microphone 112. In addition to the acoustic echo, the microphone 112 input may also contain a signal b(n) composed of background noise and/or a speech signal of near-end talker 114. The performance of conventional approaches to the cancellation of acoustic echoes strongly depends on the assumption of a linear echo path and a linear overall system. However, in applications such as hands-free telephony, interactive TV, and the like, non-negligible non-linear distortion is introduced by loudspeakers (e.g., external loudspeaker 110 and their associated amplifiers, such as external audio amplifier 108). With these non-linear distortions, strictly linear echo cancellers cannot provide strong enough echo attenuation. The remaining non-linear echo could be one tenth of its linear counterpart, or larger, in amplitude. In either case, the non-linear echo is audible enough to degrade the quality of communication in that the output signal to the far-end will contain an unacceptably high level of residual echo. Generally, even modest non-linear distortions can degrade the performance of linear AEC models considerably.

In some existing solutions, echo cancellers may use methods to handle non-linear echo components such as audio harmonics introduced into signals by communication devices. Current solutions typically require that an apriori model (e.g., a known model) and its parameters be specified for a given non-linearity for a given communication device. Typically, this is estimated in a factory-based tuning of the communication device immediately after manufacture and/or before use by an end-user. In modern communication devices that connect to external audio systems, however, no apriori model parameters can be assumed, and thus the performance of the echo canceller is compromised.

### BRIEF SUMMARY

Methods, systems, and apparatuses are described for detecting, quantifying, and compensating for non-linear characteristics of audio signals, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 is a block diagram representation of a linear echo cancellation system.

FIG. 2 is a block diagram of a phone terminal, according to an exemplary embodiment.

FIG. 3 is a block diagram of a non-linearity compensator, according to an exemplary embodiment.

FIG. 4 is a block diagram of a pre-distortion circuit, according to an exemplary embodiment.

FIG. 5 is a block diagram of a pre-processing echo canceller circuit, according to an exemplary embodiment.

FIG. 6 is a block diagram of a non-linear, post-processing echo suppressor circuit, according to an exemplary embodiment.

FIG. 7 is a block diagram of a memoryless non-linearity model/circuit, according to an exemplary embodiment.

FIGS. 8A-8C show block diagrams associated with a non-linearity memory model/circuit, according to exemplary embodiments.

FIG. 9 is a flowchart providing a process for detecting, quantifying, and compensating for acoustic non-linearities, according to an exemplary embodiment.

FIG. 10 is a flowchart providing a process for providing an indication to a user that a tuning operation is to be performed, according to an exemplary embodiment.

FIG. 11 is a flowchart providing a process for tuning a phone terminal, according to an exemplary embodiment.

FIG. 12 is a flowchart providing a process for detecting, quantifying, and compensating for acoustic non-linearities, according to an exemplary embodiment.

FIG. 13 is a block diagram of a computer system, according to an exemplary embodiment.

FIG. 14 shows higher-order statistic techniques in Table 1 and Table 2 for illustrative clarity, and according to exemplary embodiments.

Embodiments will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### 1. Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. The embodiments described herein may be used separately or in conjunction with one another in any combination and are not to be considered mutually exclusive.

Furthermore, references in the specification to “echo cancellation,” “echo suppression,” and/or “non-linearity compensation,” refer to the reduction and/or the elimination of non-linear echo and/or non-linear audio components. As used herein, “echo cancellation” and “echo suppression” are example types of “non-linearity compensation.” References to linear echo cancellation are specifically described as “linear” or in the context of linear systems/filters.

Still further, terminology used herein such as “about,” “approximately,” and “substantially” have equivalent meanings and may be used interchangeably.

Numerous exemplary embodiments are described as follows. It is noted that any section/subsection headings provided herein are not intended to be limiting. Embodiments are described throughout this document, and any type of embodiment may be included under any section/subsection. Furthermore, disclosed embodiments may be combined with each other in any manner

### 2. Example Embodiments

The examples described herein may be adapted to various types of electronic devices such as wired and wireless communications systems, computing systems, communication devices (e.g., telephones), interactive television technologies, and/or the like, which include, or may be coupled with, external audio amplifiers. In telephony embodiments, telephone calls may be conducted over wireless channels, Voice over Internet Protocol (“VoIP”) (e.g., Voice over Long Term Evolution (“VoLTE”)), plain old telephone service (“POTS”), and/or the like. Furthermore, additional structural and operational embodiments, including modifications/alterations, will become apparent to persons skilled in the relevant art(s) from the teachings herein.

In embodiments, electronic devices may be configured to pair or couple with external audio devices such as external audio amplifiers, external speakers, wireless headsets, vehicle systems, and/or the like. Such devices are susceptible to non-linear distortion in various forms such as, but not limited to, echo and distortion. Common sources of non-linear distortion include low-voltage batteries, low-quality speakers, over-powered amplifiers, and poorly-designed enclosures. Applications such as hands-free telephony and videoconferencing are particularly problematic due to high loudspeaker volume levels. In laptop computers and desktop speakerphones, high loudspeaker levels often lead to a non-linear effect known as Harmonic Distortion (“HD”). Under this effect, signals with high power on particular frequencies produce an increase in the power of frequencies that are multiples of the fundamental frequency (up to a certain degree or order of harmonics).

For example, an electronic device such as a communication device may be coupled to an external audio device such as an external audio amplifier used in hands free telephony by a user (e.g., the “near-end” user) of the communication device. In common usage, an audio input signal may be received by the communication device from a far-end entity such as a person on a telephone call with the user (e.g., a person using a different communication device from the near-end user to participate in the telephone call with the near-end user). The communication device provides the received input signal to the external audio device where the signal may be amplified and corresponding sounds may be broadcast by loudspeakers. Additionally, the user may speak into and/or other sounds may be received at a microphone of the external audio device. The loudspeaker sounds and user sounds may be returned to the communication device and subsequently transmitted to the far-end entity. However, non-linear audio characteristics may be introduced into the return signal by the external audio device. Such non-linear characteristics may be detected, estimated, and/or compensated for using the techniques described herein.

Non-linearities may be detected, estimated, and/or compensated for using pre- and/or post-processing techniques such as, but not limited to, distortion circuits, non-linear filters, and models of non-linear signal components that may be developed dynamically. In the embodiments described below, one or more of these techniques may be used in conjunction with other techniques, and mutual exclusivity of embodiments is not intended unless explicitly set forth.

In the illustrated embodiments presented herein, communication devices are shown for clarity and ease of description. Communication devices may be telephone (“phone”) terminals. Phone terminals may be, without limitation, wireless telephones (e.g., mobile phones, cellular phones, smart phones, etc.), land-line telephones (plain old telephone system (“POTS”) phones), computer-based telephony components (e.g., telephony components of servers, desktop computers, laptop computers, tablet computers, etc.), Internet/network devices configured for telephony, interactive televisions, other devices from which telephony may be conducted, and/or the like. It should be noted however, that the use of communication devices in the figures is not to be considered limiting and that other electronic devices described herein, and that would become apparent to a person of skill in the relevant art(s) having the benefit of this disclosure, are contemplated.

Embodiments presented herein improve non-linear acoustic cancellation by providing dynamic detection, estimation, and compensation for acoustic non-linearities. With the techniques described herein, including but not limited to, dynamic tuning operations using test tones and audio signals, non-linearity models, higher-order statistical analyses, and/or speaker-specific non-linearity memory models, non-linear acoustic echo components may be significantly reduced or eliminated from audio signals.

In an example aspect, a method in a phone terminal is disclosed. The example method is for performing acoustic echo cancellation. The method includes detecting that an external audio amplifier has been coupled to the phone terminal. The method also includes dynamically detecting an acoustic non-linearity introduced in a first audio signal by the external audio amplifier being coupled to the phone terminal. The method further includes estimating at least one non-linear parameter associated with the acoustical non-linearity in response to the detection. The method also includes compensating for the detected acoustic non-linearity in the first audio signal based at least upon the at least one estimated non-linear parameter to generate an echo-cancelled audio signal.

In another example aspect, a phone terminal is disclosed that includes an amplifier detector, a non-linearity detector, a non-linearity estimator, and a non-linearity compensator. The amplifier detector is configured to detect that an external audio amplifier has been coupled to the phone terminal. The non-linearity detector is configured to dynamically detect an acoustic non-linearity introduced in a first audio signal by the external audio amplifier being coupled to the phone terminal. The non-linearity estimator is configured to estimate at least one non-linear parameter associated with the acoustical non-linearity in response to the detection. The non-linearity compensator is configured to compensate for the detected acoustic non-linearity in the first audio signal based at least upon the at least one estimated non-linear parameter to generate an echo-cancelled audio signal.

In yet another example aspect, a computer-readable storage medium having computer-executable instructions recorded thereon for causing a processing device of a phone terminal to execute a method for performing acoustic echo cancellation is disclosed.

Various example embodiments are described in the following subsections. In particular, example telephone terminal embodiments are described, followed by example embodiments for non-linearity compensation circuits. The exemplary non-linearity compensation circuit embodiments include embodiments for pre-distortion circuits, pre-processing echo cancellers, and post-processing echo suppressors. Example embodiments of higher-order statistics and example non-linearity model embodiments are subsequently described, including descriptions of small loudspeaker models and large loudspeaker models. Descriptions of these embodiments are followed by descriptions of further example embodiments and advantages, example operational embodiments, and example computer-implemented embodiments.

### 3. Example Telephone Terminal Embodiments

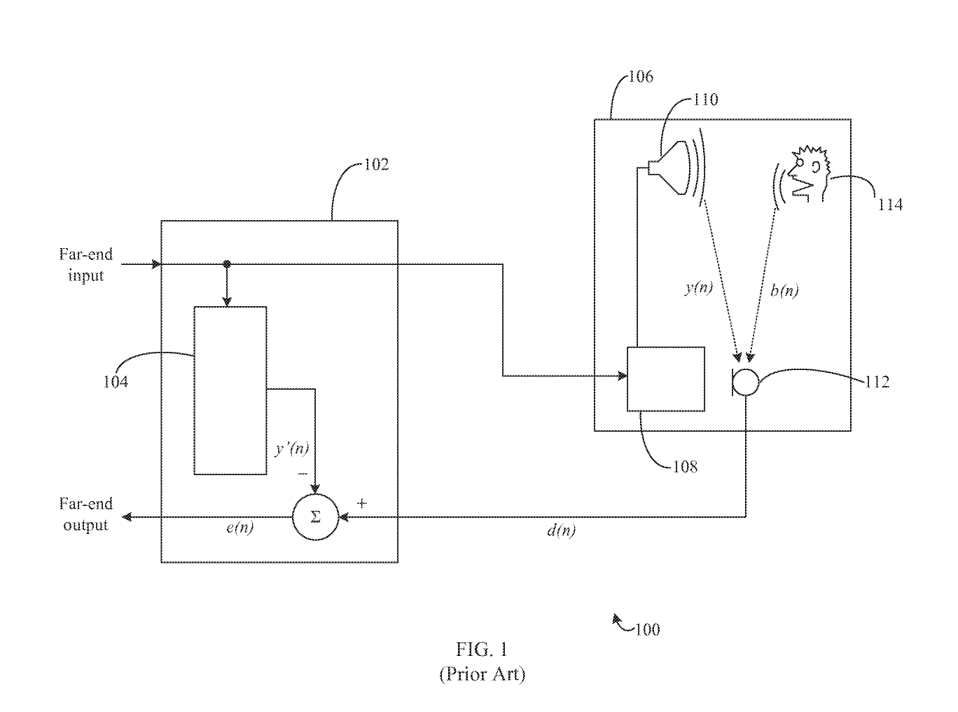

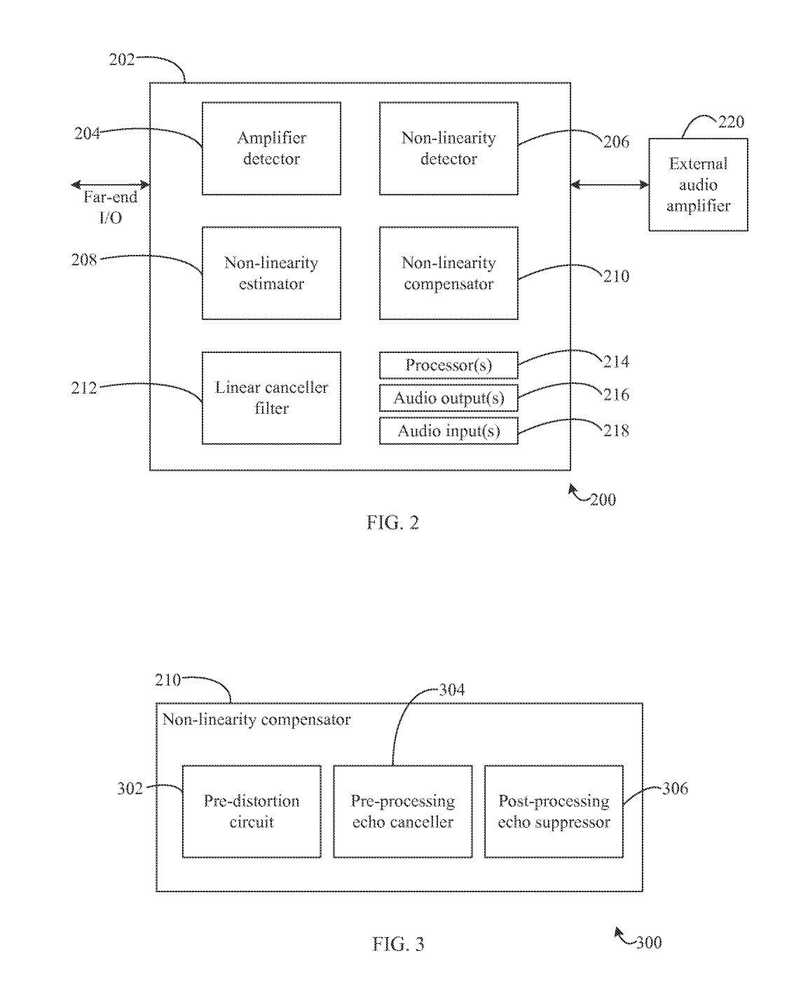

A telephone terminal (“phone terminal”) may be configured in various ways to perform detection of, estimation of, and/or compensation for acoustic non-linearities in audio signals, according to the embodiments herein. For example, FIG. 2 shows a block diagram of a phone terminal system 200, according to an embodiment. Phone terminal system 200 includes a phone terminal 202. Phone terminal 202 is configured to transmit signals to, and receive signals from, a far-end entity using far-end input and output (“I/O”) interfaces (not shown). In the embodiment of FIG. 2, phone terminal 202 includes an amplifier detector 204, a non-linearity detector 206, a non-linearity estimator 208, and a non-linearity compensator 210. As shown, phone terminal 202 also includes a linear canceller filter 212, one or more processor(s) 214, one or more audio output interface(s) 216, and one or more audio input interface(s) 218. Still further, phone terminal system 200 may also include an external audio amplifier 220. In embodiments, it is contemplated that external audio amplifier 220 may include one or more of the features shown in near-end room 106 of FIG. 1, such as external audio amplifier 108 and/or one or more external loudspeakers 110. However, for clarity of illustration and description, only external audio amplifier 220 is shown in FIG. 2 and referenced in the described embodiments. In other words, references herein to an external audio amplifier may refer to configurations such as: an audio amplifier device (e.g., an electronic device that amplifies an electrical audio signal), an audio amplifier device paired with one or more loudspeakers (devices that convert an electrical audio signal to sound), or one or more loudspeakers (e.g., a loudspeaker system).

Phone terminal system 200 and each of the components included therein may include functionality and connectivity beyond what is shown in FIG. 2, as would be apparent to persons skilled in relevant art(s) having the benefit of this disclosure. However, such additional functionality is not shown in FIG. 2 for the sake of brevity.

As shown in FIG. 2, phone terminal 202 may be paired with or coupled to external audio amplifier 220. Phone terminal 202 and external audio amplifier 220 may be coupled using wired or wireless techniques as described herein and/or otherwise known. As will be described in the embodiments herein, various components of phone terminal 202 may be used, alone or in conjunction with other components, to detect, estimate, and compensate for acoustic non-linearities associated with coupling phone terminal 202 with external audio amplifier 220.

Phone terminal 202, when coupled to external audio amplifier 220, is configured to provide external audio amplifier 220 with audio signals and tones. Furthermore, phone terminal 202 is configured to receive broadcast sounds and/or signals based upon the provided audio signals and tones from external audio amplifier 220, according to embodiments.

For example, during normal operation by a user, speech, music, audio signals associated with multimedia applications or video, and/or the like may be provided to external audio amplifier 220 from phone terminal 102 for broadcast from one or more loudspeakers associated therewith. Additionally, in embodiments for tuning operations and/or performance of techniques to detect, estimate, and/or compensate for acoustic non-linearities in audio signals, phone terminal 202 is configured to provide audio signals and tones such as, but not limited to, Gaussian noise, one or more audio tones, one or more audio tones of different frequencies, speech signals, and/or other design-specific audio signals to external audio amplifier 220. In each instance, audio signals and tones may be provided using an output interface such as one or more of audio output interface(s) 216.

With respect to sounds generated by external audio amplifier 220, during normal operation by a user, speech, music, audio signals associated with multimedia applications or video, and/or the like may be received from external audio amplifier 220 by a near-end user, as well as phone terminal 202. Additionally, in embodiments, phone terminal 202 is configured to receive audio signals and tones such as, but not limited to, Gaussian noise, one or more audio tones, one or more audio tones of different frequencies, speech signals, and/or other design-specific audio signals based on corresponding sound that was broadcast by one or more loudspeakers associated with external audio amplifier 220. In each instance, audio signals and tones may be received using an input interface such as one or more of audio input interface(s) 218, and may be stored on phone terminal 202 using one or more of its components or a memory as described below.

The illustrated components of phone terminal 202 will now be described in further detail.

Amplifier detector 204 may be configured to detect that an external audio amplifier (e.g., external audio amplifier 220) has been coupled to a phone terminal (e.g., phone terminal 202). Accordingly, amplifier detector 204 may include circuitry and/or sub-components associated with wireless connections and/or wired connections between phone terminal 202 and external audio amplifier 220, in embodiments. For example, amplifier detector 204 may include circuitry configured to detect wireless communications associated with a coupled external amplifier. Alternatively, amplifier detector 204 may poll and/or receive a signal from a wireless module of phone terminal 202 (not shown) indicating an external audio amplifier has been coupled thereto. In embodiments, detection circuitry may be included in amplifier detector 204 that is electrically or communicatively coupled to an audio output (e.g., audio output interface(s) 216) or an audio input (e.g., audio input interface(s) 218) through which an external audio amplifier is coupled. In this manner, amplifier detector 204 may be configured to detect an external audio amplifier that is physically connected to phone terminal 202 in a wired fashion (e.g., using a connector jack, a cord or cable, etc.). Amplifier detector 204 may communicate a detection of external audio amplifier 220 to one or more other components of phone terminal 202.

Non-linearity detector 206 may be configured to dynamically detect an acoustic non-linearity introduced in an audio signal due to external audio amplifier 220 being coupled to phone terminal 202. Non-linearity detector 206 may dynamically detect acoustic non-linearities using one or more of the techniques described herein. For example, return audio signals based on sound broadcast from external audio amplifier 220 such as, but not limited to, Gaussian noise, one or more audio tones, one or more audio tones of different frequencies, or other design-specific audio signals may be analyzed by non-linearity detector 206. In an embodiment, if non-linearity detector 206 determines that the return audio signal has non-zero higher order statistics, this determination is a detection of a non-linearity in the return audio signal, in one or more embodiments. For instance, a higher-order correlation and/or cross-correlation analysis may be performed by non-linearity detector 206 to detect non-linearities in audio signals, and a higher-order bispectrum and/or cross-bispectrum analysis may also be performed by non-linearity detector 206. In embodiments, if the higher-order analysis results in non-zero harmonic components, a detection of a non-linearity is confirmed. In contrast, a higher-order analysis that results in zero harmonic components may be indicative of a lack of non-linear components in the audio signal. Detection of non-linearities is described in further detail in the sections below.

Non-linearity estimator 208 may be configured to estimate at least one non-linear parameter associated with an acoustical non-linearity detected by non-linearity detector 206 in response to the detection. Non-linearity estimator 208 may estimate non-linear parameters associated with the acoustical non-linearities using one or more of the techniques described herein. For example, by analyzing the third-order cross-correlation and/or the third-order cross-bispectrum of return signals at one or a plurality of frequencies, non-linear parameters associated with the acoustical non-linearity may be estimated. In one embodiment, a higher order statistical (“HOS”) analysis (e.g., a 2^{nd} order and/or a 3^{rd} order analysis) may be performed on the return audio signal, and a two-dimensional, discrete Fourier transform (“2D-DFT”) or fast Fourier transform (“2D-FFT”) may be taken from the HOS analysis to determine a magnitude(s) of non-linear parameters. For instance, a higher-order correlation and/or cross-correlation analysis may be performed, and a higher-order bispectrum and/or cross-bispectrum analysis may be performed by non-linearity estimator 208 to estimate non-linear parameters in audio signals. In embodiments, the higher-order bispectrum and/or cross-bispectrum analysis, e.g., in the frequency domain using Fourier transforms, may provide non-linear parameters such as, but not limited to, a frequency and/or a magnitude of one or more non-linearities. Estimation of non-linear parameters is described in further detail in the sections below.

Non-linearity compensator 210 may be configured to compensate for the detected acoustic non-linearity in the audio signal based at least upon one or more estimated non-linear parameter(s) determined by non-linearity estimator 208 to generate an echo-cancelled audio signal. Non-linearity compensator 210 may compensate for acoustic non-linearities using one or more of the techniques described herein. For example, non-linearity compensator 210 may perform a linearization of the external audio amplifier using a pre-distortion circuit, and/or may remove or reduce at least a portion of the acoustic non-linearity using a pre-processing echo canceller, a post-processing echo suppressor, and/or a distortion circuit each of which is described in further detail below. In embodiments, other compensation techniques may be used as would be apparent to a person of skill in the relevant arts having the benefit of this disclosure.

Linear canceller filter 212 may be configured to model the linear echo path. The linear filter model may be used by linear canceller filter 212 to subtract linear echo components from audio signals (e.g., audio signals received from an external audio amplifier such as external audio amplifier 220).

Processor(s) 214 may include one or more of a central processing unit(s) (“CPU”), a microcontroller(s), a digital signal processor(s) (“DSP”), application specific integrated circuits (“ASICs”), programmable arrays, and/or the like. Processor(s) 214 are configured to perform functions in accordance with the embodiments and techniques described herein, such as but not limited to, detections, determinations, analyses, mathematical computations, etc. Processor(s) 214 may be based on different technologies, may be single or multi-core, and may be configured to communicate with one or more memories (not shown) of phone terminal 202.

Audio output interface(s) 216 may include small speakers, large speakers, audio interfaces or connections, and/or the like, configured to transmit audio signals in wired and/or wireless manners. For instance, in embodiments an audio output interface of audio output interface(s) 216 may provide an audio signal to external audio amplifier 220 via a wired and/or a wireless connection.

Audio input interface(s) 218 may include one or more microphones, audio interfaces or connections, and/or the like, configured to receive audio signals in wired and/or wireless manners. For instance, in embodiments, a microphone(s) and/or an audio input interface of audio input interface(s) 218 may receive an audio signal from external audio amplifier 220 via sounds broadcast from a loudspeaker and/or via a wired and/or a wireless connection. In some embodiments, a microphone may comprise an input connector configured to receive audio signal inputs from one or more wired and/or wireless connections.

Phone terminal 202 may also include user input interfaces (e.g., a keypad, a touch screen, volume buttons, a power button, etc.), a display, status indicators, input and output signal ports, and/or the like, which are not shown for the sake of brevity and clarity of illustration. Furthermore, each component of phone terminal 202 may communicate with one or more other components of phone terminal 202, however, these connections are not shown in FIG. 2 for illustrative clarity.

Phone terminal system 200 and each of the components included therein may be implemented in hardware, or a combination of hardware with software and/or firmware.

Referring now to FIG. 3, a block diagram of a non-linearity compensator system 300 is shown. Non-linearity compensator system 300 may be a further embodiment of non-linearity compensator 210 shown in FIG. 2. For instance, as shown, non-linearity compensator system 300 includes non-linearity compensator 210. In the illustrated embodiment, non-linearity compensator 210 includes a pre-distortion circuit 302, a pre-processing echo canceller 304, and a post-processing echo suppressor 306. In embodiments, one or more of pre-distortion circuit 302, pre-processing echo canceller 304, and post-processing echo suppressor 306 may be included in non-linearity compensator system 300 and/or utilized to perform their respective functions and operations as described herein.

For instance, pre-distortion circuit 302 may be configured to perform a linearization of a received far-end audio signal. In embodiments, pre-distortion circuit 302 may perform the linearization in conjunction with other components of phone terminal 202, models, higher-order statistical analyses, and/or tuning operations, as described elsewhere herein. For instance, pre-distortion circuit 302 may be configured to linearize an output audio signal provided to external audio amplifier 220 of FIG. 2 via audio output interface(s) 216. Advantageously, a standard linear canceller filter (e.g., linear canceller filter 212 of FIG. 2) may be sufficient to cancel the echo in a linearized return signal from external audio amplifier 220 (based on the linearized output signal provided). Further details regarding the operations and functions of pre-distortion circuit 302 are discussed below.

Pre-processing echo canceller 304 may be configured to remove at least a portion of one or more acoustic non-linearities in an audio signal. In embodiments, pre-processing echo canceller 304 may remove one or more non-acoustic linearities in conjunction with other components of phone terminal 202, models, higher-order statistical analyses, and/or tuning operations, as described elsewhere herein. For instance, in embodiments, pre-processing echo canceller 304 may provide a model of a non-linear path (i.e., non-linearities introduced in the signal as it traverses an external audio amplifier) to be combined with the outputs of a linear canceller filter (e.g., linear canceller filter 212 of FIG. 2). Advantageously, the outputs of pre-processing echo canceller 304 and a standard linear canceller filter (e.g., linear canceller filter 212) may be sufficient to cancel the linear and non-linear echo in a return signal from external audio amplifier 220 based on a provided/estimated non-linear model and a linear model. Further details regarding the operations and functions of pre-processing echo canceller 304 are discussed below.

Post-processing echo suppressor 306 may be configured to remove at least a portion of the acoustic non-linearity in an audio signal. In embodiments, post-processing echo suppressor 306 may remove one or more acoustic non-linearities in conjunction with other components of phone terminal 202, higher-order statistical analyses, models, and/or tuning operations, as described elsewhere herein. For instance, in embodiments, post-processing echo suppressor 306 may utilize a model of a non-linear path (i.e., non-linearities introduced in the signal as it traverses an external audio amplifier) and/or sub-band frequency estimations to generate a cancellation signal to be combined with a return signal and provided to a post-processing and/or synthesis circuit/logic. Further details regarding the operations and functions of post-processing echo suppressor 306 are discussed below.

Non-linearity compensator system 300 and each of the elements included therein may be implemented in hardware, or a combination of hardware with software and/or firmware.

### 4. Example Non-Linearity Compensation Circuit Embodiments

A simple basic solution to removing residual non-linear echo is simply to mute the whole residual signal obtained at the output of an echo canceller, whenever only the far-end participant is talking. This approach, often referred to as the Non-Linear Processor (NLP), is commonly used to attenuate any type of residual echo and involves substituting the signal with a comfort noise that emulates the spectral characteristics of the near-end noise signal. However, because NPL can only be applied during single talk segments (i.e., when only the far-end is talking), it often causes discontinuous speech during double talk periods (both near-end and far-end persons are talking) and results in fluctuations of the perceived level of residual echo, which can be perceptually objectionable. The following described techniques alleviate and/or overcome this deficiency in the current state of the art.

As noted in the above-described exemplary phone terminal embodiments, echo cancellation and non-linearity compensation may be performed in various ways by one or more circuits/logic of phone terminal 202. For example, with reference to FIGS. 2 and 3, non-linearity compensator 210, pre-distortion circuit 302, pre-processing echo canceller 304 and/or post-processing echo suppressor 306 may be used to compensate for non-linearities and cancel non-linear echo components in audio signals introduced by an external audio amplifier (e.g., external audio amplifier 220). Example circuits for non-linearity compensation are described in this Section.

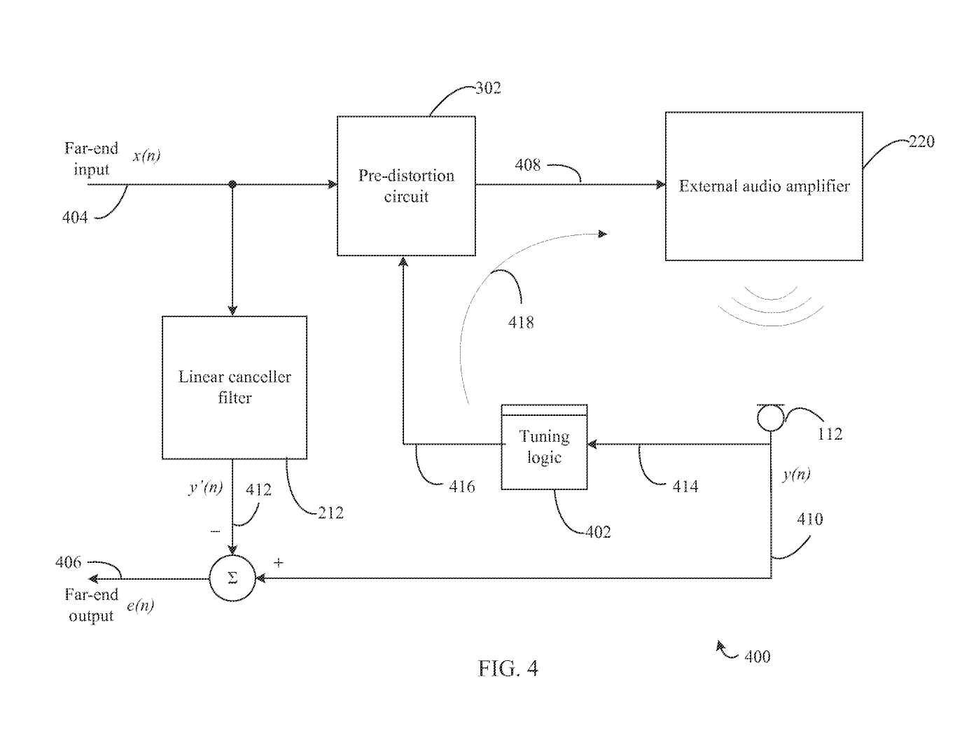

Referring to FIG. 4, a block diagram of a pre-distortion circuit echo canceller system 400 configured to perform non-linearity compensation is described, according to embodiments. Pre-distortion circuit echo canceller system 400 may be included in an embodiment of phone terminal system 200 described with respect to FIG. 2 above, and provides an example implementation of pre-distortion circuit 302 described with respect to FIG. 3 above.

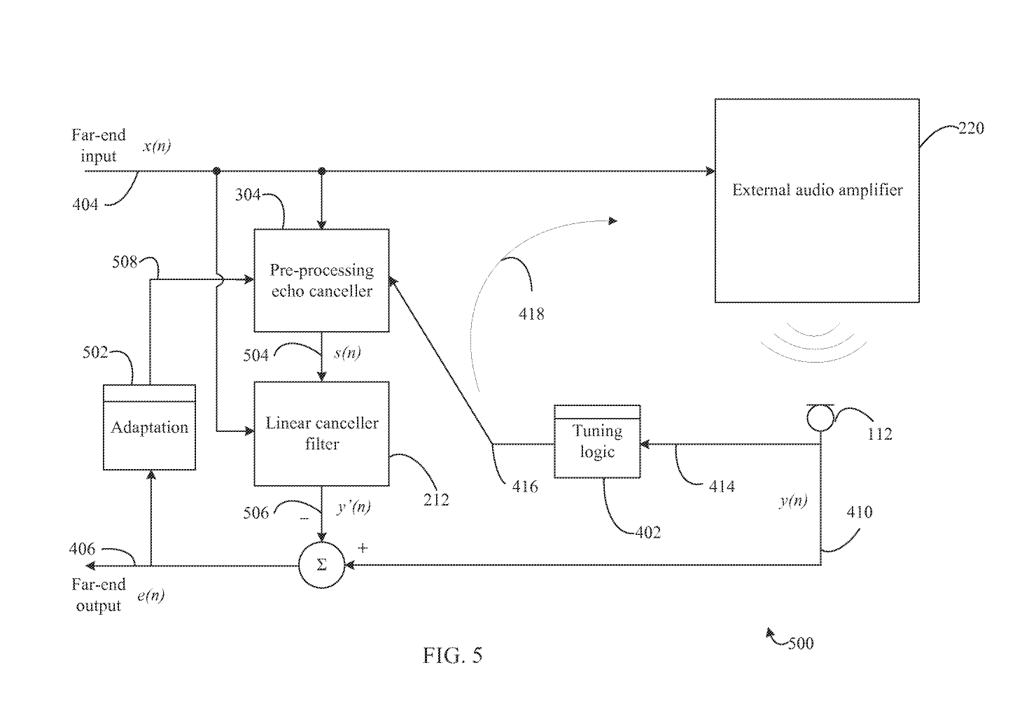

FIG. 5 shows a block diagram of a pre-processing echo canceller system 500 configured to perform non-linearity compensation, according to embodiments. Pre-processing echo canceller system 500 may be included in an embodiment of phone terminal system 200 described with respect to FIG. 2 above, and provides an example implementation of pre-processing echo canceller 304 described with respect to FIG. 3 above.

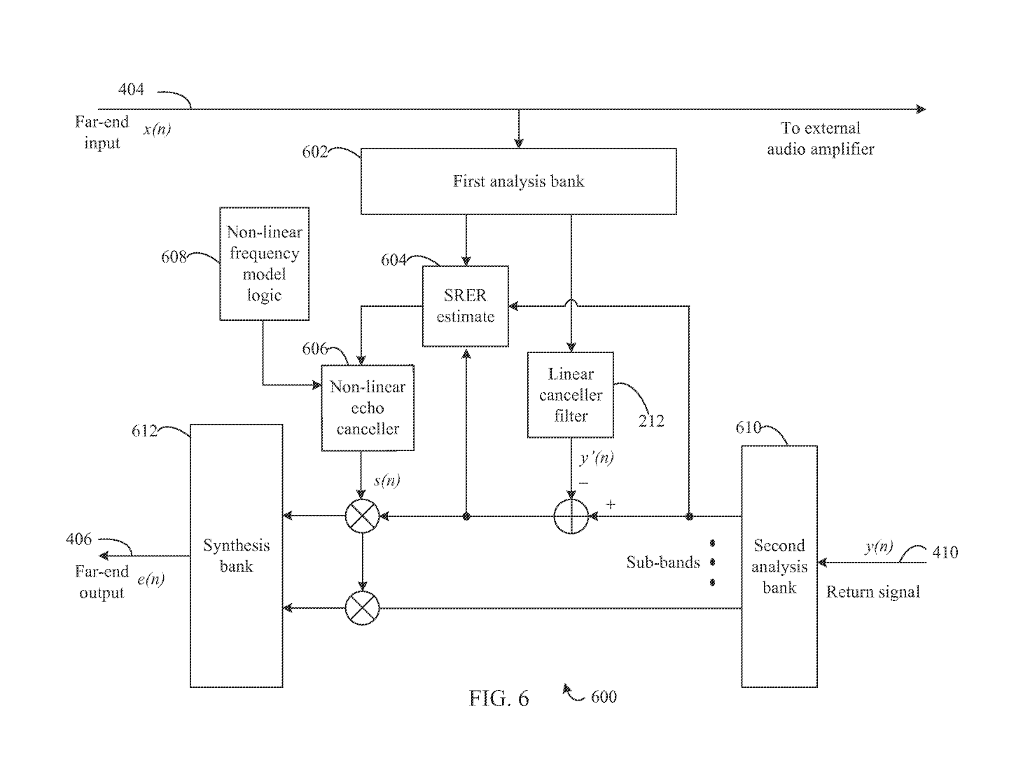

FIG. 6 shows a block diagram of a post-processing echo suppressor system 600 configured to perform non-linearity compensation, according to embodiments. Post-processing echo suppressor system 600 may be included in an embodiment of phone terminal system 200 described with respect to FIG. 2 above, and provides an example implementation of post-processing echo suppressor 306 described with respect to FIG. 3 above.

It should be noted that pre-distortion circuit echo canceller system 400, pre-processing echo canceller system 500, and post-processing echo suppressor system 600 are described in separate figures for the sake of illustrative clarity, and it is contemplated that these exemplary embodiments may be combined in one or more combinations and jointly utilized in one or more embodiments.

### A. Example Pre-Distortion Circuit Embodiments

Pre-processing, such as digital pre-processing, may be performed on a far-end received signal to compensate for the non-linearity of an external audio amplifier. As described above, pre-distortion circuit 302 may be configured to perform a linearization for a received far-end audio signal based upon an audio signal provided to an external amplifier (e.g., external audio amplifier 220). In an embodiment, pre-distortion circuit 302 may be a digital processor (i.e., a digital pre-processor) and may be configured to perform the linearization in conjunction with other components of phone terminal 202, models, higher-order statistical analyses, and/or tuning operations. As shown in FIG. 4, pre-distortion circuit echo canceller system 400 may include pre-distortion circuit 302. Furthermore, as shown in FIG. 4, pre-distortion circuit echo canceller system 400 may include microphone 112, linear canceller filter 212, external audio amplifier 220, and a tuning logic 402. Additional components and connections may also be included (e.g., as shown in phone terminal 202 of FIG. 2) as would be apparent to persons of skill in the relevant art(s), but are not shown in FIG. 4 for the sake of brevity.

FIG. 4 shows a far-end input signal 404 (“x(n)”) that is received from a far-end entity by pre-distortion circuit 302 and linear canceller filter 212. For instance, a first user having a telephone or other communication device (that includes pre-distortion circuit echo canceller system 400) may conduct a telephone call with a second user at another communication device. Far-end input signal 404 may be received from the device of the second user participating in the call, and far-end input signal 404 may include voice of the second user. Pre-distortion circuit 302 processes far-end input signal 404 to generate an output audio signal 408 that is received by external audio amplifier 220. External audio amplifier 220 outputs sound at a loudspeaker based on output audio signal 408. Microphone 112 generates a return signal 410 (“y(n)”) based on receiving the sound. It is noted that although not illustrated in FIG. 4, return signal 410 may be amplified (by one or more amplifiers) and/or filtered (by one or more filters), as desired in a particular application. As represented in FIG. 4 by a summer, return signal 410 may be combined with an estimated echo signal 412 (“y′(n)”) generated by linear canceller filter 212. Linear canceller filter 212 generates estimated echo signal 412 based on far-end input signal 404 to be an estimate of the echo return signal y(n) from a loudspeaker of external audio amplifier 220. Estimated echo signal 412 is subtracted from return signal 410. The resulting signal is transmitted to the far-end entity as a far-end output signal 406 (“e(n)”).

As described above, pre-distortion circuit 302 processes far-end input signal 404 to generate output audio signal 408, which is provided to external audio amplifier 220. Output audio signal 408 may be generated by pre-distortion circuit 302 to cause a complete, substantially complete, or partially complete linearization of the echo path (i.e., the audio signal path traversing external audio amplifier 220), so that linear canceller filter 212 is sufficient to remove most or all echo from far-end output signal 406. In this manner, far-end output signal 406 may be substantially comprised of the speech signal of the near-end talker and/or background noise (e.g., “b(n)”). In embodiments, pre-distortion circuit 302 processes audio signals according to an algorithm that is approximately the inverse of the non-linear channel response of external audio amplifier 220. Accordingly, an apriori knowledge of the non-linear characteristics of external audio amplifier 220 may be used, or obtained for use by training/tuning, e.g., using tuning logic 402. The apriori knowledge may be obtained via training/tuning after the coupling of an external audio amplifier, e.g., by a user, is detected.

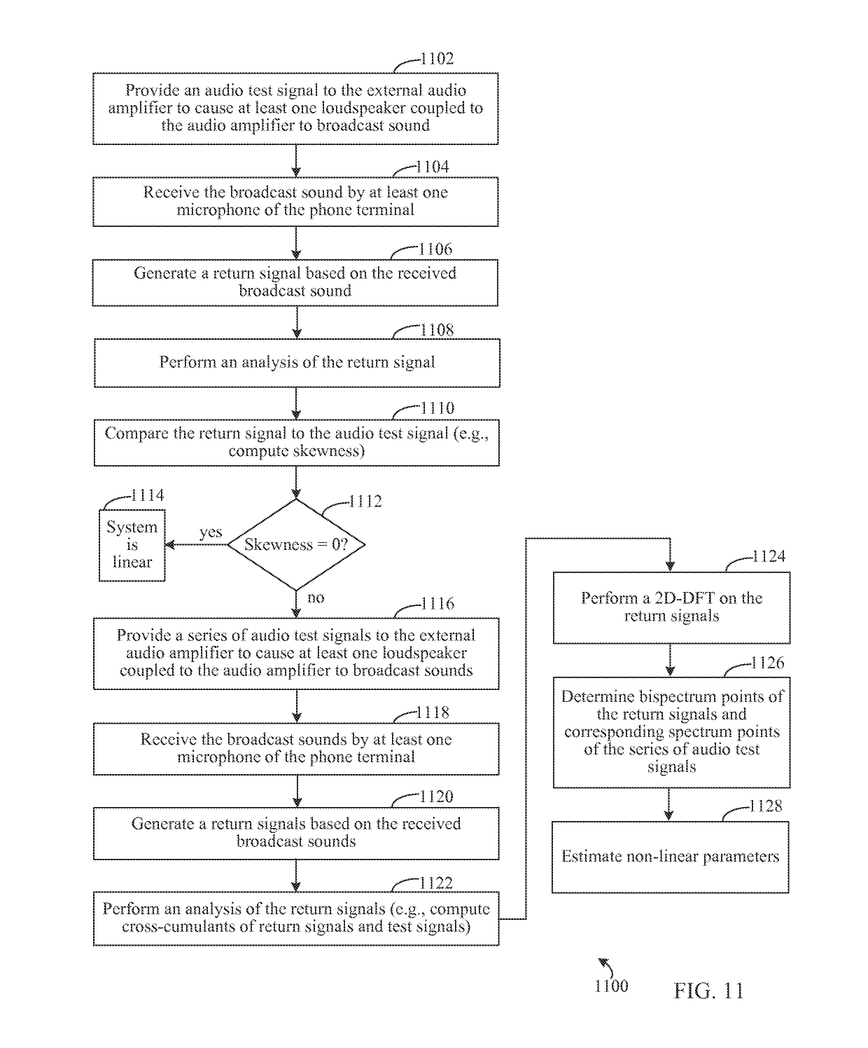

For instance, sound broadcast from a loudspeaker associated with external audio amplifier 220 may be used to perform training/tuning using tuning logic 402. In embodiments, tuning logic 402 may comprise non-linearity estimator 208 of FIG. 2 described above. In some embodiments, tuning logic 402 may operate in accordance with one or more of the steps described below in flowchart 1100 of FIG. 11.

For example, in one exemplary embodiment of tuning logic 402, one or more audio test signals 418 may be generated (e.g., by tuning logic 402) that are transmitted to external audio amplifier 220 to cause at least one loudspeaker coupled to external audio amplifier 220 to broadcast sound(s). When multiple test signals are included in audio test signals 418, each signal may be a tone of a different frequency, amplitude, and/or phase. The broadcast sound(s) may be received by a microphone 112 of phone terminal 202, which generates a return signal 414 based on the received broadcast sound(s). Note that any number of microphones may be present that generate corresponding return signals. Tuning logic 402 (e.g., non-linearity estimator 208 of FIG. 2), may analyze return signal 414 to generate an estimation of non-linear audio signal parameters. Tuning logic 402 may output the estimated parameters as estimated non-linear audio signal parameters 416. In embodiments, the analysis may include performing one or more of a third-order statistical cross-correlation analysis between audio test signals 418 and return signal 414 to generate a third-order cross-correlation(s), a third-order statistical cross-bispectrum analysis between audio test signals 418 and return signal 414 to generate a third-order cross-bispectrum(s), and/or an additional third-order statistical analysis between audio test signals 418 and return signal 414. Accordingly, estimating non-linear parameters may be based upon the third-order cross-correlation, the third-order cross-bispectrum and/or additional statistical results at one or more signal frequencies.

Pre-distortion circuit 302 receives estimated non-linear audio signal parameters 416. Pre-distortion circuit 302 may process subsequently received far-end input signals 404 based on estimated non-linear audio signal parameters 416 to linearize the echo path associated with external audio amplifier 220. In other words, pre-distortion circuit 302 may pre-distort far-end input signal 404 according to estimated non-linear audio signal parameters 416 to generate output audio signal 408. Sound is broadcast by external audio amplifier 220 based on output audio signal 408, and the pre-distortion of output audio signal 408 and non-linear response of external audio amplifier 220 substantially cancel to result in a linearization of the echo path through external audio amplifier 220. Return signal 410 is generated based on the sound received at microphone 112, and has reduced (if not eliminated) non-linear distortion. As described above, linear canceller filter 212 removes any linear echo from return signal 410 (via the summer) to be transmitted as far-end output signal 406.

In some embodiments, pre-distortion circuit 302 may be implemented in a digital form (thus acting on the digital samples of the receive signal) or it may be implemented as analog circuitry acting on the analog signal immediately before an external amplifier. In alternate embodiments, pre-distortion circuit 302 may be placed after the external amplifier and before the loudspeakers; it may also be placed anywhere on the analog signal path spanning the input to the amplifier all the way to the input of the loudspeakers.

### B. Example Pre-Processing Echo Canceller Embodiments

Pre-processing may also be performed on a return signal based upon a far-end received signal having traversed an external audio amplifier. Such pre-processing may compensate for the non-linearity of an external audio amplifier. This pre-processing approach may be thought of as a “mirror” of pre-processing pre-distortion circuit 302 of FIG. 3, in that pre-processing may model the non-linear path, instead of trying to linearize it. In a pre-processing embodiment, a non-linear filter or function (e.g., a truncated Volterra filter and/or a memoryless power function, described in the following sections) may be placed prior to a linear echo canceller in order to recreate non-linear components substantially similar to those on the return signals generated by a microphone of a phone terminal Modeling the non-linearities allows them to be removed effectively. An exemplary pre-processing embodiment is now described with respect to FIG. 5.

As shown in FIG. 5, pre-processing echo canceller system 500 may include pre-processing echo canceller 304. Pre-processing echo canceller system 500 may also include microphone 112, linear canceller filter 212, external audio amplifier 220, tuning logic 402, and optional adaptation logic 502. Additional components and connections may also be included (e.g., as shown in phone terminal 202 of FIG. 2) as would be understood by persons of skill in the relevant art(s), but are not shown for the sake of brevity.

As noted above, pre-processing echo canceller 304 may be configured to remove at least a portion of the acoustic non-linearity in an audio signal through the pre-processing described herein. In embodiments, pre-processing echo canceller 304 may include a model and/or filter and may be configured to remove acoustic non-linearities in conjunction with other components of phone terminal 202, models, higher-order statistical analyses, and/or tuning operations.

FIG. 5 shows far-end input signal 404 (“x(n)”) received from a far-end entity by pre-processing echo canceller 304 and by linear canceller filter 212 (e.g., in a similar manner as described in the prior subsection). Far-end input signal 404 is also received by external audio amplifier 220. Pre-processing echo canceller 304 processes far-end input signal 404 to generate a pre-processed far-end input signal 504 (“s(n)”), which is received by linear canceller filter 212. Linear canceller filter 212 generates an estimated echo signal 506 (“y′(n)”) based on pre-processed far-end input signal 504 and far-end input signal 404 to be an estimate of the echo return signal y(n) from a loudspeaker of external audio amplifier 220. Linear canceller filter 212 may generate estimated echo signal 506 based on pre-processed far-end input signal 504, in a similar manner as generating estimated echo signal 412 based on far-end input signal 404 as described above with respect to FIG. 4. However, pre-processed far-end input signal 504 also includes non-linear signal components determined by pre-processing echo canceller 304 (as further described below), and therefore estimated echo signal 506 also includes these non-linear signal components.

External audio amplifier 220 outputs sound at a loudspeaker (based on far-end input signal 404), which causes return signal 410 (“y(n)”) to be generated by microphone 112 receiving the sound. Return signal 410 is combined with estimated echo signal 506 generated by linear canceller filter 212 (as represented in FIG. 5 by a summer). For instance, estimated echo signal 506 may be subtracted from return signal 410. The resulting signal is transmitted to the far-end entity as far-end output signal 406.

Estimation of non-linear parameters in return signal 410 may be performed according to the tuning operation of tuning logic 402 described in the preceding subsection. As shown in FIG. 5, tuning logic 402 may output the estimated parameters as estimated non-linear audio signal parameters 416. Pre-processing echo canceller 304 receives estimated non-linear audio signal parameters 416 and far-end input signal 504, and is configured to model the non-linear path associated with external audio amplifier 220. In other words, pre-processing echo canceller 304 generates substantially the same non-linear signal components included in return signal 410 (due to external audio amplifier 220) based on estimated non-linear audio signal parameters 416, so that these signal components may be removed. Pre-processing echo canceller 304 generates pre-processed far-end input signal 504 to include the generated non-linear signal components. Linear canceller filter 212 receives pre-processed far-end input signal 504. Linear canceller filter 212 models the linear echo path, as described above, and uses the linear model determine linear echo components. Linear canceller filter 212 generates estimated echo signal 506 to include the linear echo components (as well as the non-linear echo components determined by pre-processing echo canceller 304). Estimated echo signal 506 is subtracted from return signal 410 to remove the linear and non-linear echo components (via the summer) to generate far-end output signal 406. In this way, all or substantially all of the linear and non-linear echo may be removed from the output audio signal to be transmitted to a far-end entity by phone terminal 202.

Adaptation logic 502 is optionally present. When present, adaptation logic 502 receives far-end output signal 406, and generates an adaptation signal that is configured to adjust the non-linear filter coefficients of pre-processing echo canceller 304 in a way to match the estimated non-linear echo path. In some embodiments, detection and/or estimation of non-linear parameters may be fixed or dynamic/adaptive. For instance, dynamic/adaptive detection and/or estimation may be performed by a least mean square (“LMS”) algorithm and/or the like. Issues related to stability and convergence make detection and/or estimation of non-linear parameters difficult to achieve in that both may be based on the far-end output, which contains the error for both the linear echo cancellation, as well as the non-linear effects. To overcome this difficulty, an apriori knowledge of the model provides a starting point and a better guarantee of convergence. As noted above, this apriori knowledge may be obtained using the techniques described herein after an external audio amplifier is coupled to a telephone terminal by a user. The non-linear filter model may also be assumed as fixed for any given external audio amplifier and may be learned off-line in embodiments.

### C. Example Post-Processing Echo Suppressor Embodiments

In another embodiment, post-processing may be used to reduce non-linear echo by applying non-linear acoustic echo suppression (AEC) to further reduce any residual echo that remains after a purely linear AEC. Post-filtering of residual echo is an established technique in the context of controlling residual echoes in generalized, linear systems, and involves applying frequency-domain attenuation to different frequency bands based on an estimate of signal-to-residual-echo ratios. Some prior post-processing solutions for non-linear echo components require apriori models of non-linearities to enable their removal and must be specifically accounted for. Such solutions, however, do not dynamically/adaptively detect and model at the time of use of external audio components that introduce non-linearities. Prior solutions control gain in frequency bins based on the estimated linear residual echo at that bin, as well as echo replicas at other frequencies that are the result of the apriori non-linear model, and these solutions require that a frequency-domain model of the non-linear residual echo be determined beforehand (e.g., based on apriori knowledge at the time of manufacture). Because these models depend on the external audio components actually included in the echo path, models have to be acquired for each hardware set-up separately, and this cannot be accomplished using existing apriori methods. An exemplary embodiment is illustrated in FIG. 6.

FIG. 6 shows an exemplary block diagram of a post-processing echo suppressor system 600. Post-processing echo suppressor system 600 includes linear canceller filter 212, a first analysis bank 602, a signal-to-residual-echo ratio (“SRER”) estimator 604, a non-linear echo suppressor 606, a non-linear frequency model 608, a second analysis bank 610, and a synthesis bank 612. As shown in FIG. 6, far-end input signal 404 may be received from a far-end entity and may be provided to an external audio amplifier (e.g., external audio amplifier 220). As shown, return signal 410 may be generated from the external audio amplifier output, and far-end output signal 406 may be generated based on the described post-processing, and may be transmitted to the far-end entity.

First analysis bank 602 may receive far-end input signal 404 and may generate outputs received by SRER estimator 604 and linear canceller filter 212. SRER estimator 604 may generate estimated signal-to-residual-echo ratio values, which are received by non-linear echo suppressor 606. Non-linear echo suppressor 606 may also receive a non-linear frequency model from non-linear frequency model 608. The non-linear frequency model may indicate one or more frequencies along with such parameters such as amplitudes and phases, or other estimated parameters associated with non-linearities. Such estimated parameters may be determined by a tuning operation, such as described above with respect to tuning logic 402 (not shown in FIG. 6 for ease of illustration). Return signal 410 may be received at second analysis bank 610. Second analysis bank 610 may provide one or more sub-bands of return signal 410 to SRER estimator 604. Second analysis bank 610 may also provide one or more sub-bands of return signal 410 to be combined with one or more estimated echo signals generated by linear canceller filter 212 to remove linear echo components (e.g., by subtraction). The resulting, combined signal(s) (e.g., a linear echo cancelled return signal) may be received by SRER estimator 604, and also may be combined with non-linear signal components generated by non-linear echo suppressor 606 to generate a product of the signals which is input into synthesis bank 612. One or more sub-bands output by second analysis bank 610 (e.g., non-linear order sub-band signals) may also be combined with outputs of non-linear echo suppressor 606 to generate products of the combined signals which are input into synthesis bank 612. Synthesis bank 612 may synthesize and transmit an output audio signal to a far-end entity as far-end output signal 406.

Linear canceller filter 212 is described in detail elsewhere herein, and its function in post-processing echo suppressor system 600 may be the same as, or substantially the same as, its function in other described embodiments.

First analysis bank 602 and second analysis bank 610 may be configured to divide their respective input signal spectra into sub-bands based upon frequency. First analysis bank 602 and second analysis bank 610 may each be configured to perform their respective division operations using one or more of Fourier transforms, quadrature mirror filters (“QMFs”), polyphase sub-band decomposition, and/or the like.

SRER estimator 604 may be configured to estimate signal-to-residual-echo ratio values based upon its received inputs from one or more of first analysis bank 602, second analysis bank 610, linear echo-canceled return signals, and/or other components described herein.

Non-linear echo suppressor 606 may be a further or alternate embodiment of post-processing echo suppressor 306 of FIG. 3, and its function in post-processing echo suppressor system 600 may be the same as, or substantially the same as, its function in other described embodiments herein. For example, post-processing echo suppressor system 600 may be configured to act as a non-linear filter to cancel non-linearities in return signals based, at least in part, on inputs from one or more of SRER estimator 604, non-linear frequency model 608, and/or other components described herein. In some embodiments, non-linear echo suppressor 606 may suppress the amplitude or gain of non-linear and/or harmonic frequency components in return signals based, at least in part, on inputs from one or more of SRER estimator 604, non-linear frequency model 608, and/or other components described herein. For instance, in an embodiment, non-linear echo canceller may suppress signal components in one or more sub-bands of far-end input signal 404 at frequencies indicated by non-linear frequency model logic 608 as non-linearities, to generate signal s(n).

Non-linear frequency model 608 may be configured to determine and/or provide non-linear frequency models. In embodiments, non-linear frequency model 608 may determine and/or provide estimated models, according to embodiments described herein, as outputs. For example, as described in one or more techniques herein, acoustic non-linearities may be detected and estimated. Estimated parameters of acoustic non-linearities may be used to generate one or more frequency models 608. In some exemplary implementations, non-linear frequency model 608 may receive and store non-linear frequency models and/or non-linearity parameters that are determined/estimated as described in other embodiments herein.

Synthesis bank 612 may be configured to synthesize output audio signals based, at least in part, on the sub-bands of divided input signals (e.g., signals divided by first analysis bank 602 and/or second analysis bank 610). Synthesis bank 612 may be configured to perform its synthesis operations using one or more functions/algorithms that represent inverses of the one or more of Fourier transforms, QMFs, polyphase sub-band decomposition, and/or the like, that are performed by first analysis bank 602 and/or second analysis bank 610.

### 5. Example Embodiments of Higher-Order Statistics

As described in embodiments herein, higher-order statistics (“HOS”) may be used to detect, estimate, and/or compensate for non-linearities in audio signals. In this Section, HOS definitions are set forth as a backdrop for the exemplary non-linearity model embodiments described in Section 6 below where the HOS definitions are described in further detail in exemplary embodiments. For instance, higher-order correlation, cross-correlation, spectrum, and/or bispectrum statistical analyses may be used herein. It should be noted that in some embodiments, statistical expectations are approximated by time averaging and segmenting. For clarity of description, the exemplary definitional equations provided in this Section are denoted with alphabetical designators enclosed by parenthesis, while in the next Section, the model derivation equations are denoted with numerical designators enclosed by parenthesis.

For example, a 3^{rd} order correlation C₃ₓ of a signal x(n) is defined in Equation A:

C₃ₓ(τ₁,τ₂)=E[x(n)x(n+τ₁)x(n+τ₂)]. (A)

The bispectrum B₃ₓ is found by taking the two-dimensional Fourier transform of the 3^{rd} order correlation, and may be defined as in Equation B:

$${B}_{3 x} ( {w}_{1} , {w}_{2} ) = {\sum }_{{τ}_{1}} {\sum }_{{τ}_{2}} {C}_{3 x} ( {τ}_{1} , {τ}_{2} ) \cdot {e}^{- j ( {w}_{1} {τ}_{1} + {w}_{2} {τ}_{2} )} . \qquad ( B )$$

The bispectrum may also be expressed in terms of the Fourier transform of the original input audio signal, as in Equation C:

B₃ₓ(w₁,w₂)=E[X(w₁)X(w₂)X*(w₁+w₂)]. (C)

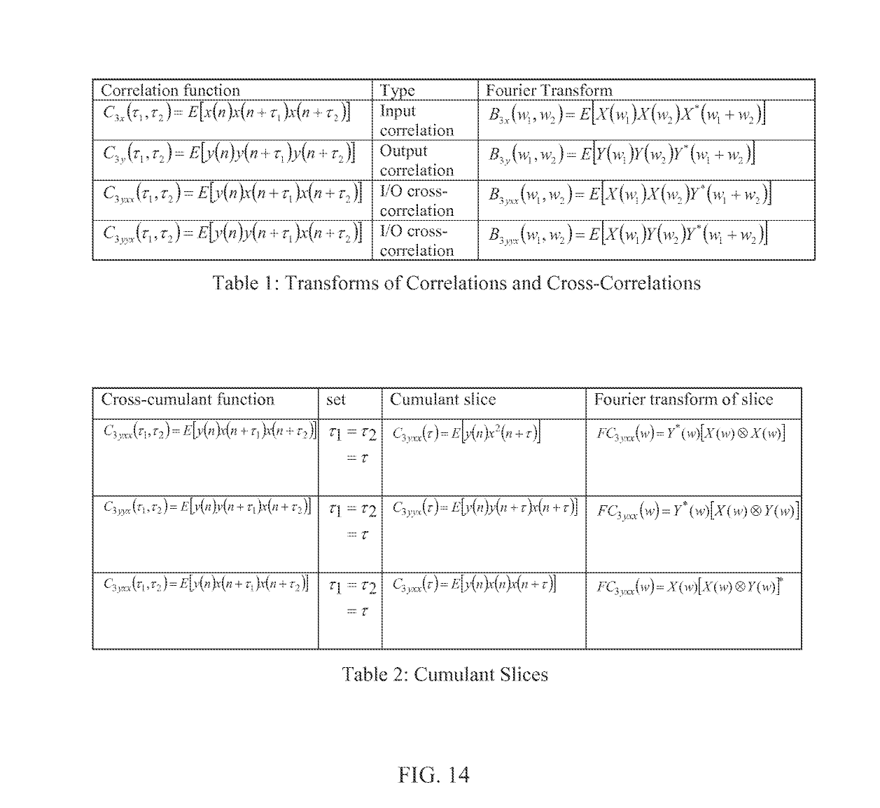

In addition to the correlation of the input audio signal, the cross-correlation between input and output audio signals is also considered. Exemplary correlation functions, including cross-correlation variants and their transforms, set forth in FIG. 14 in Table 1: Transforms of Correlations and Cross-Correlations, are considered herein.

As shown above and in Table 1, C_{# x} and C_{# y} denote correlations, where # is the correlation order, and x or y denote whether the correlation is for a signal input (x) or a signal output (y). As shown, C_{# yxx} and C_{# yyx} denote cross-correlations, where # is the cross-correlation order, and where yxx and yyx denote the combination of inputs and outputs in the cross-correlation. As shown, τ represents time (time domain), and E represents signal energy.

As shown, B represents Fourier transforms of the described correlation functions, where #, x, y, yxx, and yyx are representations used similarly as in the correlation functions. As Fourier transforms represent frequency domain equivalents, w denotes frequency, and E represents spectral energy.

The 2D-Fourier transforms of the 3^{rd} order cumulant can be written in terms of the Fourier transforms of the underlying signals. For example, the 2D-Fourier transform of Equation A is:

B₃ₓ(w₁,w₂)=E[X(w₁)X(w₂)X*(w₁+w₂)]. (D)

That is, given the practical definition of the 3^{rd} order cumulant:

$${C}_{3 x} ( {τ}_{1} , {τ}_{2} ) = {\sum }_{n} x ( n ) x ( n + {τ}_{1} ) x ( n + {τ}_{2} ) , \qquad ( E )$$

and the bispectrum is computed as the 2D-Fourier transform:

$${B}_{3 x} ( {w}_{1} , {w}_{2} ) = {\sum }_{{τ}_{1}} {\sum }_{{τ}_{2}} {C}_{3 x} ( {τ}_{1} , {τ}_{2} ) \cdot {e}^{- j ( {w}_{1} {τ}_{1} + {w}_{2} {τ}_{2} )} . \qquad ( F )$$

Through substitution with Equations E and F, it is shown that:

$${B}_{3 x} ( {w}_{1} , {w}_{2} ) = {\sum }_{{τ}_{1}} {\sum }_{{τ}_{2}} {\sum }_{n} x ( n ) x ( n + {τ}_{1} ) x ( n + {τ}_{2} ) \cdot {e}^{- j ( {w}_{1} {τ}_{1} + {w}_{2} {τ}_{2} )} . \qquad ( G )$$

When variables m=n+τ₁ and k=n+τ2, and the terms of Equation G are regrouped, then:

$${B}_{3 x} ( {w}_{1} , {w}_{2} ) = {\sum }_{{τ}_{1}} x ( m ) \cdot {e}^{- j {w}_{1} m} {\sum }_{{τ}_{2}} x ( k ) \cdot {e}^{- j {w}_{1} k} {\sum }_{n} x ( n ) \cdot {e}^{- j ( {w}_{1} + {w}_{2} ) n} , \qquad ( H )$$

or simply:

B₃ₓ(w₁,w₂)=E[X(w₁)X(w₂)X*(w₁+w₂)]. (I)

The Fourier transform equations shown above may be implemented in the various described embodiments herein.

Cumulant slices are obtained by reducing the dimension of the 3^{rd} order correlation functions described above, for example, by removing one of the two variables, by setting both variables to be the same, and/or by setting one of the variables to a constant value, such as zero.

Three exemplary cumulant slices are shown in FIG. 14, Table 2: Cumulant Slices, along with their respective Fourier transforms. The Fourier transform of the cumulant slices can be written in terms of the bispectrum of the original cumulant function. The derivations associated with the cumulant slices shown in Table 2 are now described in further detail.

With respect to the first cumulant slice, consider the cross-cumulant function:

C_{3yxx}(τ₁,τ₂)=E[y(n)x(n+τ₁)x(n+τ₂)], (J)

and reduce the variable space by specifying τ₁=τ₂=τ, to get the slice:

C_{3yxx}(τ)=E[y(n)x²(n+τ)]. (K)

The Fourier transform of this slice is:

$${FC}_{3 yxx} ( w ) = {\sum }_{τ} {\sum }_{n} y ( n ) {x}^{2} ( n + τ ) \cdot {e}^{- j w τ} . \qquad ( L )$$

By letting m=n+τ and splitting the exponential term, Equation L is shown as:

$$\begin{matrix}{FC}_{3 yxx} ( w ) = {\sum }_{m} {\sum }_{n} y ( n ) {x}^{2} ( m ) \cdot {e}^{- j wn} \cdot {e}^{j wm} \\ = {\sum }_{n} y ( n ) \cdot {e}^{j wn} {\sum }_{m} {x}^{2} ( m ) \cdot {e}^{- j wm} ,\end{matrix} \qquad ( M )$$

and thus:

FC_{3yxx}(w)=Y*(w)[X(w)\textcircled{×}X(w)]. (N)

Equation N shows a convolution of the spectrum of x(n). Equation N may also be written as:

$${FC}_{3 yxx} ( w ) = {Y}^{*} ( w ) {\sum }_{k} X ( k ) X ( w - k ) . \qquad ( {N}^{′} )$$

Now recall the bispectrum of the cumulant function:

B_{3yxx}(w₁,w₂)=E[x(w₁)x(w₂)Y*(w₁+w₂)], (O)

and sum the points of the bispectrum in the frequency plane, along the diagonal line w:

$$\begin{matrix}{\sum }_{k} {B}_{3 yxx} ( k , w - k ) = {\sum }_{k} X ( k ) X ( w - k ) {Y}^{*} ( w ) \\ = {KY}^{*} ( w ) {\sum }_{k} X ( k ) X ( w - k ) .\end{matrix} \qquad ( P )$$

Thus presented is the relation:

$${FC}_{3 yxx} ( w ) = {\sum }_{k} {B}_{3 yxx} ( k , w - k ) . \qquad ( Q )$$

The Fourier transform of the cumulant slice can therefore be written in terms of the sum of the bispectrum points along a diagonal w.

With respect to the second cumulant slice, again consider the cross-cumulant function shown in Equation J above, and let τ₁=τ₂=τ to obtain the slice:

C_{3yyx}(τ)=E[y(n)y(n+τ)x(n+τ)]. (R)

The Fourier transform may be shown as:

$${FC}_{3 yxx} ( w ) = {\sum }_{τ} {\sum }_{n} y ( n ) y ( n + τ ) x ( n + τ ) \cdot {e}^{- j w τ} , \qquad ( S )$$

and by splitting the exponent and letting m=n+τ, it may be shown that:

$$\begin{matrix}{FC}_{3 yxx} ( w ) = {\sum }_{m} {\sum }_{n} y ( n ) y ( m ) x ( m ) \cdot {e}^{- j wn} \cdot {e}^{j wm} \\ = {\sum }_{n} y ( n ) \cdot {e}^{j wn} {\sum }_{m} x ( m ) \cdot y ( m ) \cdot {e}^{- j wn} ,\end{matrix} \qquad ( T )$$

and thus:

FC_{3yxx}(w)=Y*(w)[X(w)\textcircled{×}Y(w)]. (U)

The above is a convolution of the spectrum of x(n), and may also be written as:

$${FC}_{3 yxx} ( w ) = {Y}^{*} ( w ) {\sum }_{k} X ( k ) Y ( w - k ) . \qquad ( {U}^{′} )$$

Now considering the bispectrum of the original cumulant function:

B_{3yyx}(w₁,w₂)=E[X(w₁)Y(w₂)Y*(w₁+w₂)], (V)

and summing the points of the bispectrum in the frequency plane, along the diagonal line

$$\begin{matrix}{\sum }_{k} {B}_{3 yyx} ( k , w - k ) = {\sum }_{k} X ( k ) Y ( w - k ) {Y}^{*} ( w ) \\ = {KY}^{*} ( w ) {\sum }_{k} X ( k ) Y ( w - k ) .\end{matrix} \qquad ( W )$$

Therefore:

$${FC}_{3 yyx} ( w ) = \frac{1}{K} {\sum }_{k} {B}_{{3}_{yyx}} ( k , w - k ) . \qquad ( X )$$

The Fourier Transform of the cumulant slice can be written in terms of the sum of the bispectrum points along a diagonal w.

With respect to the third cumulant slice, again consider the cross-cumulant function shown in Equation J above, and let τ₁=τ₂=τ to obtain the slice:

C_{3yxx}(τ₁,τ₂)=E[y(n)x(n+τ₁)x(n+τ₂)]. (Y)

Letting τ₁=0 and τ₂=2 the cumulant slice is:

C_{3yxx}(τ)=E[y(n)x(n)x(n+τ)], (Z)

### and its Fourier Transform is:

$${FC}_{3 yxx} ( w ) = {\sum }_{τ} {\sum }_{n} y ( n ) x ( n ) x ( n + τ ) \cdot {e}^{- j w τ} . \qquad ( AA )$$

Letting variable m=n+τ, and rewriting Equation AA shows:

$$\begin{matrix}{FC}_{{3}_{yyx}} ( w ) = {\sum }_{m} {\sum }_{n} y ( n ) x ( n ) x ( m ) \cdot {e}^{- j w n} \cdot {e}^{j wm} \\ = {\sum }_{n} x ( n ) \cdot y ( n ) \cdot {e}^{j wn} {\sum }_{m} x ( m ) \cdot {e}^{- j wm} ,\end{matrix} \qquad ( BB )$$

or simply:

FC_{3yxx}(w)=X(w)[X(w)\textcircled{×}Y(w)]*. (CC)

The transform of Equation CC involves the convolution of the spectrums of {X(w)} and Y(w), which may be implemented as:

$${FC}_{3 yxx} ( w ) = {X ( w ) [ {\sum }_{k} X ( k ) Y ( w - k ) ]}^{*} . \qquad ( {CC}^{′} )$$

Recalling the bispectrum for the cross-correlation function:

B_{3yyx}(w₁,w₂)=E[X(w₁)Y(w₂)Y*(w₁+w₂)], (DD)

and taking the sum of points along a diagonal w, then:

$$\begin{matrix}{\sum }_{k} {B}_{3 yyx} ( k , w - k ) = {\sum }_{k} X ( k ) Y ( w - k ) {Y}^{*} ( w ) \\ = {KY}^{*} ( w ) {\sum }_{k} X ( k ) Y ( w - k ) .\end{matrix} \qquad ( EE )$$

Therefore:

$${FC}_{3 yyx} ( w ) = \frac{1}{K} {\sum }_{k} {B}_{3 yyx}^{*} ( k , w - k ) . \qquad ( FF )$$

The Fourier transform of the cumulant slice can be written in terms of the sum of the bispectrum points along a diagonal w.

In view of this HOS definitions backdrop, non-linearity models are described in the following Section.

### 6. Example Non-Linearity Model Embodiments

In embodiments described herein, audio signal non-linearities (e.g., echo, distortion, and/or the like) are detected, estimated, and compensated for using a variety of components, circuits, models, and/or techniques. Common sources of non-linear distortion include low-voltage batteries, low-quality speakers, over-powered amplifiers, and/or poorly-designed enclosures. Applications such as hands-free telephony and videoconferencing are particularly problematic due to high loudspeaker volume levels. In laptop computers and desktop speakerphones, high loudspeaker levels often lead to a non-linear effect known as Harmonic Distortion (HD). Under this effect, signals with high power on particular frequencies produce an increase in the power of frequencies that are multiples of the fundamental frequency (up to a certain degree of harmonics).

As noted herein, non-linear audio components may be estimated and/or modeled such that their presence in audio signals may be reduced or eliminated. In this Section, models and mathematical algorithms are described that may be used in conjunction with one or more embodiments described herein to reduce or eliminate non-linearities. For instance, “memoryless” models for small loudspeaker parameters and analog devices with memoryless characteristics, as well as models “with memory” for large loudspeaker parameters and analog devices with memory-based characteristics are described below.

For clarity of description, the model derivation equations in this Section are denoted with numerical designators, while in the previous Section, the exemplary definitional equations are denoted with alphabetical designators.

### A. Example Small-Loudspeaker Model Embodiments

Loudspeakers, such as those used in hands-free telephony, may be categorized as small loudspeakers. Small loudspeakers tend to have memoryless non-linearity characteristics. In other words, unlike large loudspeakers, the characteristics of small loudspeakers are based on a present audio signal or excitation—not based upon prior audio signals. Furthermore, small loudspeakers may exhibit non-linearities as saturation characteristics (e.g., due to low battery voltages), and may also exhibit non-linear distortion characteristics (e.g., due to high volume usage). Small loudspeaker models therefore should consider one or both of these types of non-linearities. While various embodiments herein are described with respect to small loudspeakers, it should be noted that the described embodiments and techniques are applicable to any analog devices with memoryless characteristics such as analog amplifiers and/or equalizers.

For modeling saturation-type non-linearities for small loudspeakers, an approximation using a truncated Taylor series expansion may be used, for instance, as a sum of powers of the input signal, shown here in Equation 1:

$$\begin{matrix}s ( n ) = {\sum }_{p = 1}^{P} {α}_{p} {x}^{p} ( n ) , \\ = {a}_{1} x ( n ) + {a}_{2} {x}^{2} ( n ) + {a}_{3} {x}^{3} ( n ) + ⋯ ,\end{matrix} \qquad ( 1 )$$

where x^{p}(n) is the input audio signal received from a far-end entity, aₚ denotes the coefficients of the Taylor series expansion, and P is the order of the Taylor series.

In the overall system being modeled (e.g., phone terminal system 200, shown in FIG. 2), the propagation path between a loudspeaker (e.g., of external audio amplifier 220) and a microphone (e.g., of audio input interface(s) 218), including the microphone, is still modeled by a linear filter, thus the overall model of the echo path consists of the cascade of a memoryless non-linearity followed by a linear filter, as shown below in Equation 2 and Equation 3:

$$\begin{matrix}{y}^{′} ( n ) = {\sum }_{l = 1}^{L} g ( l ) s ( n - l ) , or & ( 2 ) \\ {y}^{′} ( n ) = {\sum }_{l = 1}^{L} {\sum }_{p = 1}^{P} g ( l ) a ( p ) {x}^{p} ( n - l ) , & ( 3 )\end{matrix}$$

where L is the length of the echo path, and g(l) are the coefficients of the filter used to model the echo path.

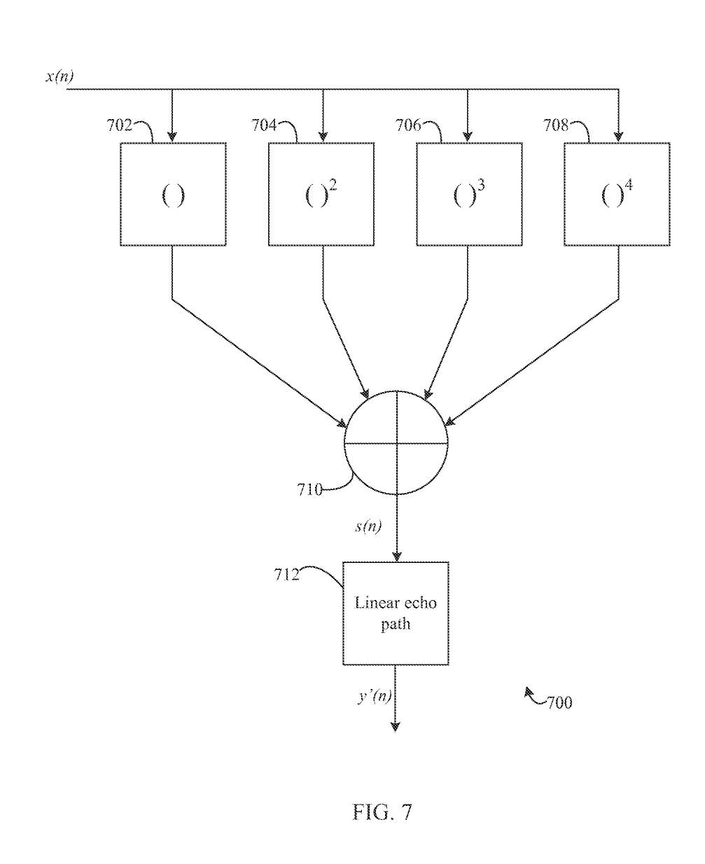

FIG. 7 shows a graphical representation of a memoryless non-linearity model 700 for small loudspeakers. Memoryless non-linearity model 700 receives x(n) (e.g., the input audio signal received from a far-end entity or an audio signal generated by a phone terminal, such as far-end input signal 404 of FIGS. 4-6) as an input, as described in Equations 1-3. The input signal is processed to estimate non-linearities. For example, a first order non-linearity 702, a second order non-linearity 704, a third order non-linearity 706, and/or a fourth order non-linearity 708 may be estimated. In embodiments, the higher order non-linearities may be representative of harmonic components introduced by an external audio amplifier. A summer 710 may receive and sum non-linearities 702, 704, 706, and 708 to calculate a sum s(n), as shown in FIG. 7 and in Equation 1 above. This model of saturation-type non-linearities may be cascaded with a linear filter that models a linear echo path. For example, as shown in FIG. 7, a linear each path 712 receives sum s(n). In embodiments, linear canceller filter 212 may be implemented in linear echo path 712. Linear echo path 712 generates a cascaded output signal y′(n). The cascaded output signal, y′(n), as shown in Equations 2-3, may then be combined with a return signal from an external audio amplifier (e.g., external audio amplifier 220) to subtract the linear and non-linear echo components, as described herein.

An input tone at a given frequency may be sent through a communication system (e.g., phone terminal system 200, shown in FIG. 2), and according to memoryless non-linearity model 700, the output contains the higher powers of the input tone, which yield harmonic frequencies of that tone. Estimating the parameters of the harmonic components entails estimating the magnitude at each of the frequency harmonics.

Thus, for example, if x(n)=a₁ sin(w₁t+θ), then:

$$\begin{matrix}{x}^{2} ( n ) -> \frac{1}{2} - \frac{{a}_{1}}{2} cos ( 2 {w}_{1} t + 2 θ ) , and & ( 4 ) \\ {x}^{3} ( n ) -> \frac{3 {a}_{1}}{4} sin ( {w}_{1} t + θ ) - \frac{{a}_{1}}{4} sin ( 3 {w}_{1} t + 3 θ ) , and & ( 5 ) \\ {x}^{4} ( n ) -> \frac{3}{8} - \frac{{a}_{1}}{2} cos ( 2 {w}_{1} t + 2 θ ) + \frac{{a}_{1}}{8} cos ( 4 {w}_{1} t + 4 θ ) . & ( 6 )\end{matrix}$$

Accordingly, the output contains harmonic frequency terms, namely:

y(n)→α₁ sin(w₁t+θ)+α₂ sin(2w₁t+2θ+α₃ sin(3w₁t+3θ), (7)

and therefore the parameters of the higher frequency terms α₁, α₂, α₃ have to be estimated. An exemplary embodiment is described as follows for illustrative purposes.

In this exemplary illustration, a quadratic non-linearity is described. For instance, consider a tone or an audio signal x(n) that is provided to an external audio amplifier (e.g., external audio amplifier 220 of FIG. 2). In embodiments, the provided tone/audio signal may be an audio test signal such as Gaussian noise or an audio tone(s) of one or more frequencies. In this example, the audio test signal tone may be x(n)=a₁ sin(2π(500)t+θ), where 500 denotes the tone frequency in Hz. The quadratic non-linearity in the return signal due to the external audio amplifier that is generated by a microphone (e.g., in audio input interface(s) 218 of FIG. 2) is y(n)=a₁·x(n)+b·x²(n). In order to determine or estimate the non-linear parameters of the return signal, a 3^{rd} order cross-correlation between the x(n) and y(n) is computed as C_{3yxx}(τ₁,τ₂)=E[y(n)x(n+τ₁)x(n+τ₂)]. The statistical expectation may be approximated by time averages, and thus the signal may be divided into segments over which the cross-correlation is computed and summed. The average over the summed segments may be taken as:

$${C}_{3 yxx} ( {τ}_{1} , {τ}_{2} ) = {\sum }_{n} y ( n ) x ( n + {τ}_{1} ) x ( n + {τ}_{2} ) .$$

Once the cumulant function is computed for one or more time lags, a two-dimensional, fast Fourier transform (“2D-FFT”) may be determined as:

$${B}_{3 yxx} ( {w}_{1} , {w}_{2} ) = {\sum }_{{τ}_{1}} {\sum }_{{τ}_{2}} {C}_{3 yxx} ( {τ}_{1} , {τ}_{2} ) \cdot {e}^{- j ( {w}_{1} {τ}_{1} + {w}_{2} {τ}_{2} )} .$$

It can also be shown that another representation of the cross-bispectrum, in terms of the Fourier transforms of x and y is: B_{3yxx}(w₁,w₂)=E[X(w₁)X(w₂)Y*(w₁+w₂)].

Because the exemplary tone frequency is 500 Hz, the values of the bispectrum are taken at (500,500), and the value of the Spectrum of the return signal at 500 Hz. From these values, the quadratic component is deduced at 1000 Hz, because: B_{3yxx}(w₁,w₂)=E[X(w₁)X(w₂)Y*(w₁+w₂)], and thus:

$$\vert {Y}^{*} ( {w}_{1} + {w}_{2} ) \vert = \frac{\vert {B}_{3 yxx} ( {w}_{1} , {w}_{2} ) \vert}{\vert X ( {w}_{1} ) \vert \vert X ( {w}_{2} ) \vert} .$$

The numerator is the measured value, and the denominator is the known magnitude of the tone:

$$\vert Y ( 1000 ) \vert = \frac{\vert {B}_{3 yxx} ( 500 , 500 ) \vert}{\vert X ( 500 ) \vert \vert X ( 500 ) \vert} .$$

Now described is a further example of that shown immediately above, in which 2^{nd} and 3^{rd} order non-linearities are estimated. As previously noted, the signal provided to the external audio amplifier is x(n)=a₁ sin(2π(500)t+θ), but here, the return signal is y(n)=a₁·x(n)+b·x²(n)+c·x³(n). In this example, two different cross-correlations are computed:

C_{3yxx}(w₁,w₂)=E[y(n)x(n+τ₁)x(n+τ₂)] and

C_{3yyx}(τ₁,τ₂)=E[y(n)y(n+τ₁)x(n+τ₂)].

Performing 2D-FFT of the cross-correlations yield two bispectrum results, respectively:

B_{3yxx}(w₁,w₂)=E[X(w₁)X(w₂)Y*(w₁+w₂)] and

B_{3yyx}(w₁,w₂)=E[X(w₁)Y(w₂)Y*(w₁+w₂)].

From the first bispectrum expression, the component at 1000 Hz is obtained by considering the bispectrum magnitude at frequency pair (500,500) Hz:

$$\vert Y ( 1000 ) \vert = \frac{\vert {B}_{3 yxx} ( 500 , 500 ) \vert}{\vert X ( 500 ) \vert \vert X ( 500 ) \vert} .$$

Then, given the estimate of the quadratic component (i.e., at 1000 Hz), the second cross-bispectrum expression yields the 3^{rd} order component (i.e., the component at 1500 Hz):

$$\vert Y ( 1500 ) \vert = \frac{\vert {B}_{3 yxx} ( 500 , 1000 ) \vert}{\vert X ( 1000 ) \vert \vert X ( 500 ) \vert} .$$

To further the above examples and generalize to determining a k^{th} order non-linearity, the progression from 2^{nd} order component to 3^{rd} order component described above may be recursively continued to a k^{th} order approximation. For instance the 3^{rd} order component Y(1500) may be used in a similar manner in the bispectrum expression with the original tone X(500) to recover the 4^{th} order component:

$$\vert Y ( 2000 ) \vert = \frac{\vert {B}_{3 yyx} ( 500 , 1500 ) \vert}{\vert X ( 1500 ) \vert \vert X ( 500 ) \vert} .$$

The recursive determinations may continue in this manner until each non-linear component up to and including the k^{th} order non-linearity are estimated.

### B. Example Large Loudspeaker Model Embodiments

Large loudspeakers have non-linearities characterized by strong harmonics whose energy depends on the excitation frequency (i.e., the current audio signal) as well as past history inputs (i.e., memory-based inputs). The non-linear behavior of common electrodynamic loudspeakers can thus be modeled by Volterra filters, i.e., a non-linearity with memory. Limiting the Volterra filter model to a 2^{nd} or a 3^{rd} order approximation is generally enough to capture a large percentage of the perceptually significant non-linearities, although higher-order models are contemplated herein. While the embodiments herein are described with respect to large loudspeakers, it should be noted that the described embodiments and techniques are applicable to any analog devices with memory-based characteristics such as analog amplifiers and/or equalizers.

For example, a Volterra filter model may be expressed according to Equation 8 below (shown out to the third order element, but not limited thereto):

$$s ( n ) = {\sum }_{m}^{ } {h}_{1} ( m ) x ( n - m ) + {\sum }_{m}^{ } {\sum }_{k}^{ } {h}_{2} ( m , k ) x ( n - m ) x ( n - k ) + {\sum }_{m}^{ } {\sum }_{k}^{ } {\sum }_{l}^{ } {h}_{3} ( m , k ) x ( n - m ) x ( n - k ) x ( n - l ) + … , \qquad ( 8 )$$

where each order element includes a coefficient h_{order}, x(n) is the input audio signal, m is the number of memory samples for the first order element, k is the number of memory samples for the second order element, and l is the number of memory samples for the third order element. A sum of these non-linearity Volterra order elements may be calculated to produce s(n), as shown in Equation 8. In some embodiments, the non-linearity Volterra model s(n) may be cascaded with a linear filter that models the linear echo. A cascaded output signal y′(n), similar to that shown in Equations 2-3 above, may then be combined with a return signal from an external audio amplifier (e.g., external audio amplifier 220) to subtract the linear and non-linear echo components, such as is described above with respect to FIGS. 4-6.

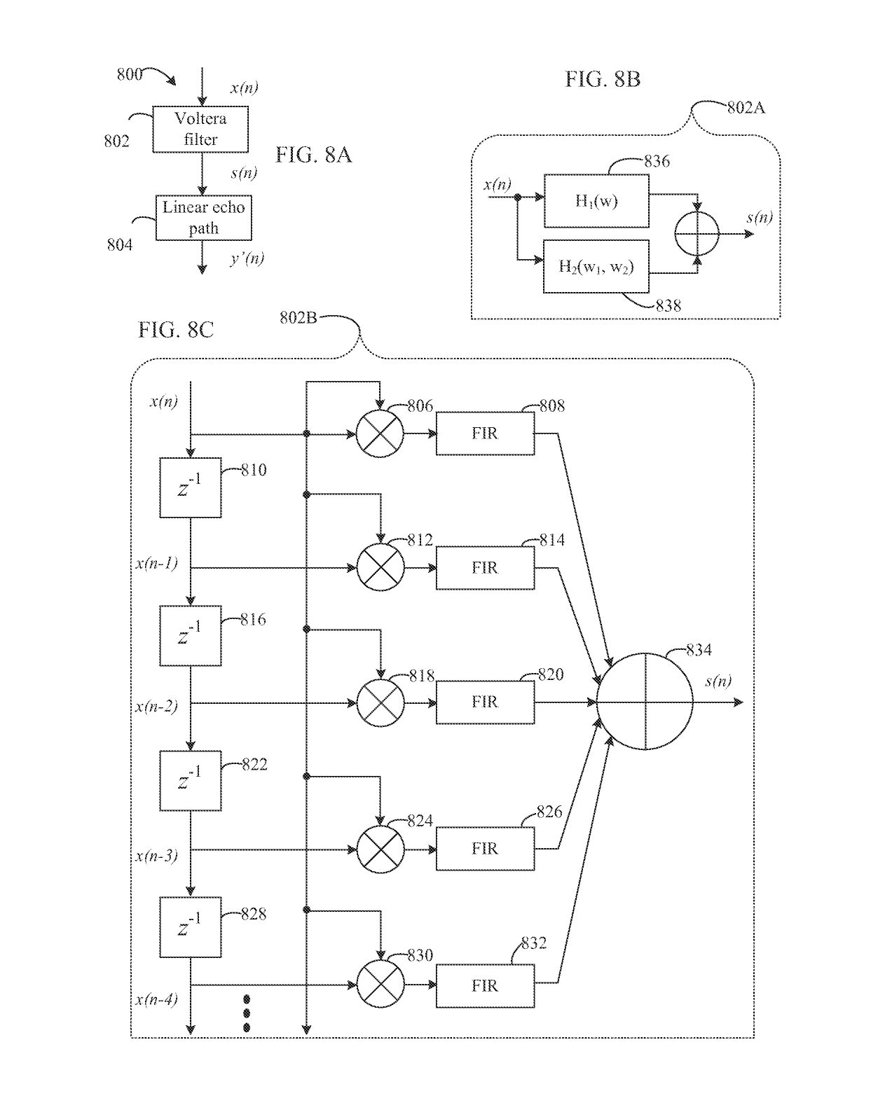

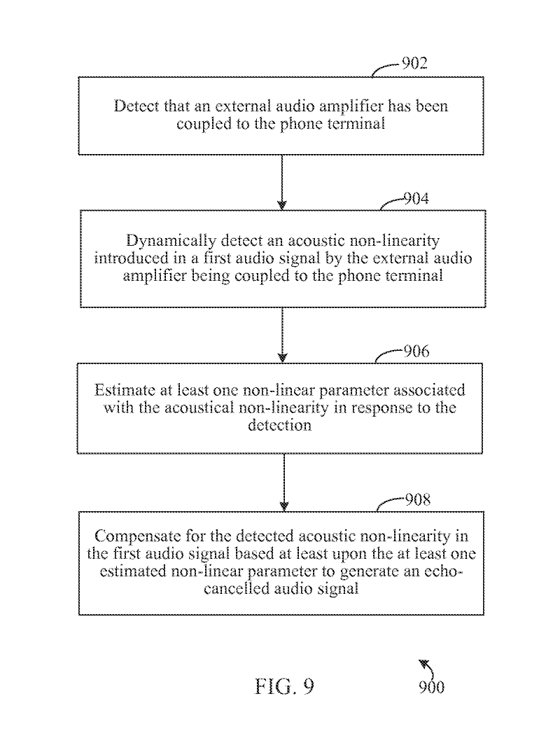

FIGS. 8A-8C show graphical representations associated with a non-linearity memory model with memory for large loudspeakers, according to example embodiments. FIG. 8A shows a non-linearity memory model 800. As shown in FIG. 8A, a non-linearity memory model 800 includes a Volterra filter 802 and a linear echo path 804. For instance, Volterra filter 802 may include a second order, truncated Volterra filter model:

$${y}^{′} ( n ) = {\sum }_{m}^{ } {h}_{1} ( m ) x ( n - m ) + {\sum }_{m}^{ } {\sum }_{k}^{ } {h}_{2} ( m , k ) x ( n - m ) x ( n - k ) , \qquad ( 9 )$$

that is cascaded with linear echo path 804, which may include a linear filter model implemented according to Equations 2 and 3. As such, in an embodiment, Volterra filter 802 may operate according to Equation 8 and/or Equation 9, and linear echo path 804 may operate in a cascaded fashion according to Equations 2 and 3. It should be noted that higher-order models are contemplated in the embodiments herein. In embodiments, linear canceller filter 212 may be implemented in linear echo path 804. The cascaded output signal, y′(n), may be combined with a return signal from an external audio amplifier (e.g., external audio amplifier 220) to subtract the linear and non-linear echo components, as described herein.

Exemplary embodiments of Volterra filter 802 are described in further detail as follows.

In embodiments, Volterra filter 802 of FIG. 8A may be represented as a quadratic Volterra filter 802A, as shown in FIG. 8B. For instance, if the non-linearity(ies) present is/are limited only to the quadratic component (e.g., as in large loudspeakers), then given the output of a memory-based model stimulated by a Gaussian input signal, a linear order component 836 of quadratic Volterra filter 802A may be recovered by considering the spectrum and cross-spectrum of the Gaussian signal. A quadratic order component 838 of quadratic Volterra filter 802A may be recovered by considering the cross-bispectrum and the individual spectra. The outputs of linear order component 836 and quadratic order component 838 may be summed and provided as the output for Volterra filter 802.

For instance, the frequency response of the linear order component 836 may be represented as Equation 10:

$${H}_{1} ( w ) = \frac{{S}_{2 yx} ( w )}{{S}_{2 x} ( w )} , \qquad ( 10 )$$

and the frequency response of the quadratic order component 838 may be represented as Equation 11:

$${H}_{1} ( {w}_{1} , {w}_{2} ) = \frac{{B}_{3 yxx} ( {w}_{1} , {w}_{2} )}{{S}_{2 x} ( {w}_{1} ) {S}_{2 x} ( {w}_{2} )} . \qquad ( 11 )$$

Equation 10 may be derived as follows. Consider the 2^{nd} order cross-correlation between x(n) and the non-linear system output y(n) in Equation 12:

C_{2yx}(τ₁)=E[y(n)x(n+τ₁)], (12)

and the output of the 2^{nd} order Volterra filter of quadratic Volterra filter 802A that contains linear order component 836 (h₁) and quadratic order quadratic order component 838 (h₂) shown in Equation 9 above. By substitution, Equation 13 is:

$${C}_{2 yx} ( {τ}_{1} ) = {\sum }_{m}^{ } {h}_{1} ( m ) E [ x ( n - m ) x ( n + {τ}_{1} ) ] + {\sum }_{m}^{ } {\sum }_{k}^{ } {h}_{2} ( m , k ) E [ x ( n - m ) x ( n - k ) x ( n + {τ}_{1} ) ] . \qquad ( 13 )$$

If the underlying input signal x(n) is a Gaussian process, then its 3^{rd} order moment is zero:

E[x(n−m)x(n−k)x(n+τ₁)]=0, (14)

and thus

$${C}_{2 yx} ( {τ}_{1} ) = {\sum }_{m}^{ } {h}_{1} ( m ) E [ x ( n - m ) x ( n + {τ}_{1} ) ] . \qquad ( 15 )$$

The cross-spectrum may be defined as shown in Equation 16:

$${S}_{2 yx} ( {w}_{1} ) = {\sum }_{{τ}_{1}}^{ } {C}_{2 yx} ( {τ}_{1} ) \cdot {e}^{- j ( {w}_{1} {τ}_{1} )} . \qquad ( 16 )$$

Therefore:

$$\begin{matrix}{S}_{2 yx} ( {w}_{1} ) = {\sum }_{{τ}_{1}}^{ } {\sum }_{m}^{ } {h}_{1} ( m ) E [ x ( n - m ) x ( n + {τ}_{1} ) ] \cdot {e}^{- j ( {w}_{1} {τ}_{1} )} \\ = {\sum }_{{τ}_{1}}^{ } {\sum }_{m}^{ } {h}_{1} ( m ) {R}_{xx} ( m + {τ}_{1} ) \cdot {e}^{- j ( {w}_{1} {τ}_{1} )} .\end{matrix} \qquad ( 17 )$$

By substitution of (τ₁+m)→k:

$$\begin{matrix}{S}_{2 yx} ( {w}_{1} ) = {\sum }_{k}^{ } {R}_{2 xx} ( m ) \cdot {e}^{- j ( {w}_{1} k )} {\sum }_{m}^{ } {h}_{1} ( m ) \cdot {e}^{- j ( {w}_{1} m )} , \\ and & ( 18 ) \\ {S}_{2 yx} ( w ) = {S}_{2 x} ( w ) \cdot {H}_{1} ( w ) . & ( 19 )\end{matrix}$$

Accordingly, Equation 10 is proven:

$${H}_{1} ( w ) = \frac{{S}_{2 yx} ( w )}{{S}_{2 x} ( w )} . \qquad ( 10 )$$

Equation 11 may be derived as follows. Consider the 3^{rd} order cross-correlation between x(n) and the non-linear system output y(n) in Equation 20:

C_{3yxx}(τ₁,τ₂)=E[y(n)x(n+τ₁)x(n+τ₂)], (20)

and the output of the 2^{nd} order Volterra filter of quadratic Volterra filter 802A that contains linear order component 836 (h₁) and quadratic order quadratic order component 838 (h₂) shown in Equation 9 above. By substitution, Equation 21 is:

$${C}_{3 yxx} ( {τ}_{1} , {τ}_{2} ) = {\sum }_{m}^{ } {h}_{1} ( m ) E [ x ( n - m ) x ( n + {τ}_{1} ) ] + {\sum }_{m}^{ } {\sum }_{k}^{ } {h}_{2} ( m , k ) E [ x ( n - m ) x ( n - k ) x ( n + {τ}_{1} ) x ( n + {τ}_{2} ) ] . \qquad ( 21 )$$

If the underlying input signal x(n) is a Gaussian process, then its 3^{rd} order moment is zero, similarly as shown in Equation 14 above, and its 4^{th} order moment can be written in terms of its 2^{nd} order moments:

$$E [ x ( n - m ) x ( n - k ) x ( n + {τ}_{1} ) x ( n + {τ}_{2} ) ] = 3 \cdot E [ x ( n - m ) x ( n + {τ}_{1} ) ] \cdot E [ x ( n - k ) x ( n + {τ}_{2} ) ] = 3 \cdot {R}_{xx} ( {τ}_{1} - m ) \cdot {R}_{xx} ( {τ}_{2} - k ) . \qquad ( 22 )$$

The 3^{rd} order cross-cumulant thus becomes:

$${C}_{3 yxx} ( {τ}_{1} ) = {\sum }_{m} {\sum }_{k} {h}_{2} ( m , k ) \cdot {R}_{xx} ( {τ}_{1} - m ) \cdot {R}_{xx} ( {τ}_{2} - k ) . \qquad ( 23 )$$

The 3^{rd} order cross-bispectrum may be defined as shown in Equation 24:

$${B}_{3 yxx} ( {w}_{1} , {w}_{2} ) = {\sum }_{{τ}_{1}} {\sum }_{{τ}_{2}} {C}_{3 yxx} ( {τ}_{1} , {τ}_{2} ) \cdot {e}^{- j ( {w}_{1} {τ}_{1} + {w}_{2} {τ}_{2} )} . \qquad ( 24 )$$

From a substitution using Equations 23 and 24, Equation 25 is obtained:

$${B}_{3 x} ( {w}_{1} , {w}_{2} ) = {\sum }_{{τ}_{1}} {\sum }_{{τ}_{2}} {\sum }_{m} {\sum }_{k} {h}_{2} ( m , k ) \cdot {R}_{xx} ( {τ}_{1} - m ) \cdot {R}_{xx} ( {τ}_{2} - k ) \cdot {e}^{- j ( {w}_{1} {τ}_{1} + {w}_{2} {τ}_{2} )} . \qquad ( 25 )$$

By further substitution of (τ₁−m)→a; (τ₂−k)→b:

$$\begin{matrix}{B}_{3 yxx} ( {w}_{1} , {w}_{2} ) = {\sum }_{a} {R}_{xx} ( a ) \cdot {e}^{- j ( {w}_{1} a )} {\sum }_{b} {R}_{xx} ( b ) \cdot \\ {e}^{- j ( {w}_{1} b )} {\sum }_{m} {\sum }_{k} {h}_{2} ( m , k ) \cdot {e}^{- j ( {w}_{1} {τ}_{1} + {w}_{2} {τ}_{2} )} \\ = {S}_{2 x} ( {w}_{1} ) \cdot {S}_{2 x} ( {w}_{2} ) \cdot H ( {w}_{1} , {w}_{2} ) ,\end{matrix} \qquad ( 26 )$$

Accordingly, Equation 11 is proven:

$${H}_{1} ( {w}_{1} , {w}_{2} ) = \frac{{B}_{3 yxx} ( {w}_{1} , {w}_{2} )}{{S}_{2 x} ( {w}_{1} ) {S}_{2 x} ( {w}_{2} )} . \qquad ( 11 )$$

As previously noted, the outputs of linear order component 836 and quadratic order component 838 may be summed and provided as the output for Volterra filter 802.

In embodiments, Volterra filter 802 of FIG. 8A may be represented as an expanded Volterra filter 802B, as shown in FIG. 8C, in accordance with Equation 9. Volterra filter 802B of FIG. 8C is described as follows. The exemplary embodiment described below may be considered as a simplified quadratic model in which the quadratic component may be simplified to the main diagonal, instead of a full matrix. It should be noted that for sake of clarity of illustration and due to space constraints, a memory sample size of four (‘4’) is illustrated, although more or fewer memory samples may be implemented in embodiments.

Volterra filter 802 includes a first delay 810, a second delay 816, a third delay 822, and a fourth delay 828. First delay 810 receives present audio input x(n) to generate a first delayed input x(n−1), second delay 816 receives first delayed input x(n−1) to generate a second delayed input x(n−2), third delay 822 receives second delayed input x(n−2) to generate a third delayed input x(n−3), and fourth delay 828 receives third delayed input x(n−3) to generate a fourth delayed input x(n−4). Volterra filter 802 also includes a first multiplier 806, a second multiplier 812, a third multiplier 818, a fourth multiplier 824, and a fifth multiplier 830 that all receive a first input of present audio input x(n), and respectively receive and multiply with the first input a second input of present audio input x(n), first delayed input x(n−1), second delayed input x(n−2), third delayed input x(n−3), and fourth delayed input x(n−4) to generate corresponding first-fifth product outputs. Still further, Volterra filter 802 includes a first finite impulse response (“FIR”) filter 808, a second FIR filter 814, a third FIR filter 820, a fourth FIR filter 826, and a fifth FIR filter 832 that each receive and filter a corresponding one of the first-fifth product outputs to generate first-fifth filtered product outputs.

Volterra filter also includes a summer 834. The first-fifth filtered product outputs of the described FIR filters are received by summer 834 where the outputs are combined into a signal s(n), as shown in Equation 9 above.

An embodiment for a simplified Volterra model of expanded Volterra filter 802A shown in FIG. 8B is described as follows. Recall the output of expanded Volterra filter 802A in Equation 9 and the 3^{rd} order cross-correlation between x(n) and the non-linear system output y(n) in Equation 20. Considering a single one-dimensional slice of the two-dimensional, 3^{rd} order cross-correlation by setting τ₁=0, Equation 27 may be shown as:

C_{3yxx}^{1D}(τ)=E[y(n)x(n)x(n+τ)]. (27)

A simplified Volterra model output y(n) consisting of the linear part and the main diagonal from the quadratic part gives Equation 28:

$$y ( n ) = {\sum }_{m} {h}_{1} ( m ) x ( n - m ) + {\sum }_{m} {h}_{2} ( m , m ) {x}^{2} ( n - m ) , \qquad ( 28 )$$

and the one-dimensional slice of Equation 27 becomes:

$${C}_{3 yxx}^{1 D} ( τ ) = {\sum }_{m} {h}_{1} ( m ) E [ x ( n - m ) x ( n ) x ( n + τ ) ] + {\sum }_{m} {h}_{2} ( m , m ) E [ {x}^{2} ( n - m ) x ( n ) x ( n + τ ) ] . \qquad ( 29 )$$

For an underlying input signal x(n) that is a sinusoidal audio tone at a frequency w1, the 3^{rd} order moment is zero:

E[x(n−m)x(n)x(n+τ)]=0. (30)

The 4^{th} order moment may be evaluated as:

$$\begin{matrix} E ⌊ {x}^{2} ( n - m ) x ( n ) x ( n + τ ) ⌋ \to E ⌊ {x}^{3} ( n ) x ( n + τ + m ) ⌋ , \\ and & ( 31 ) \\ E [ {x}^{3} ( n ) x ( n + τ + m ) ] \approx \frac{1}{T} {\int }_{0}^{T} {a}_{1}^{4} {cos}^{3} ( {w}_{1} t ) cos [ {w}_{1} ( t + τ + m ) ] \cdot d t = \frac{3 {a}_{1}^{4}}{8} cos [ {w}_{1} ( τ + m ) ] . & ( 32 )\end{matrix}$$

The 3rd order cross-cumulant slice thus becomes:

$${C}_{3 yxx}^{1 D} ( τ ) = \frac{3 {a}_{1}^{4}}{8} {\sum }_{m} {h}_{2} ( m , m ) \cdot cos [ {w}_{1} ( τ + m ) ] , \qquad ( 33 )$$

and the one-dimensional Fourier transform of this one-dimensional slice is:

$$\begin{matrix}{FC}_{3 yxx}^{1 D} ( w ) = {\sum }_{τ} {C}_{3 yxx}^{1 D} ( τ ) \cdot {e}^{- j w τ} \\ = \frac{3 {a}_{1}^{4}}{8} {\sum }_{τ} {\sum }_{m} {h}_{2} ( m , m ) \cdot cos [ {w}_{1} ( τ + m ) ] \cdot {e}^{- j w τ} .\end{matrix} \qquad ( 34 )$$

By substitution of (τ+m) k and exponential splitting, Equation 35 is derived as:

$$\begin{matrix}{FC}_{3 yxx}^{1 D} ( w ) = \frac{3 {a}_{1}^{4}}{8} {\sum }_{τ} {\sum }_{m} {h}_{2} ( m , m ) \cdot cos [ {w}_{1} k ] \cdot {e}^{- j wk} \cdot {e}^{j wm} \\ = \frac{3 {a}_{1}^{4}}{8} {\sum }_{m} {h}_{2} ( m , m ) \cdot {e}^{j w m} \cdot {\sum }_{τ} cos [ {w}_{1} k ] \cdot {e}^{- j wk} .\end{matrix} \qquad ( 35 )$$

The one-dimensional Fourier transform thus becomes:

$${FC}_{3 yxx}^{1 D} ( w ) = \frac{3 {a}_{1}^{4}}{8} \cdot {H}_{2}^{*} ( w ) \cdot [ \frac{1}{2} δ ( w - {w}_{1} ) + \frac{1}{2} δ ( w + {w}_{1} ) ] . \qquad ( 36 )$$

Comparing Equation 36 with the power spectrum of input signal x(n) shown as:

$${P}_{x} ( w ) = \frac{{a}_{1}^{2}}{2} \cdot [ \frac{1}{2} δ ( w - {w}_{1} ) + \frac{1}{2} δ ( w + {w}_{1} ) ] , \qquad ( 37 )$$

the value of the Volterra filter at frequency w1 can be shown as Equation 38:

$${{H}_{2}^{*} ( {w}_{1} ) = \frac{{FC}_{3 yxx}^{1 D} ( w )}{3 / 2 {\{ {P}_{x} ( w ) \}}^{2}} \vert}_{w = {w}_{1}} . \qquad ( 38 )$$

The Volterra filter value may then be applied to compensate for (e.g., reduce and/or eliminate) non-linear components introduced by external audio devices such as external audio amplifiers described herein.

The small and large loudspeaker models described in this Section may be used in conjunction with other embodiments described in the sections herein to compensate for acoustic non-linearities.

### 7. Further Example Embodiments and Advantages

The embodiments described herein enable the detection, estimation, and compensation for non-linearities in audio signals. Embodiments provided for performing detection, estimation, and compensation can improve audio signal quality when using external audio devices coupled to communication devices. It is contemplated, however, that the embodiments described may be applicable to strategies and implementations for detection, estimation, and compensation for non-linearities other than those explicitly set forth herein. For example, additional higher-order statistics may be used. Similarly, various electronic and computing devices may use the techniques described herein in various combinations. Likewise, other test signals (in addition to Gaussian noise and tones of various frequencies) may be used to detect and estimate non-linear parameters. Further, infrastructures and protocols other than POTS, wireless/cellular, and VoIP may also benefit from the techniques and embodiments as described above.

The techniques described herein may also advantageously be used in estimating a bulk delay associated with a phone terminal and its coupled external audio amplifier, estimating an energy imbalance between a left audio channel and a right audio channel, and/or adding one or more TAPs to reduce an algorithmic delay associated with one or more of the dynamically detecting, estimating, and/or compensating for non-linearities, as would be apparent to a person of skill in the relevant art(s) having the benefit of this disclosure.

It will be recognized that the systems, their respective components, and/or the techniques described herein may be implemented in hardware, or hardware combined with software and/or firmware, including being implemented as hardware logic/electrical circuitry. The disclosed technologies can be put into practice using implementations of hardware or hardware combined with software and/or firmware other than those described herein. Any hardware or hardware combined with software and/or firmware implementations suitable for performing the functions described herein can be used, such as those described in the following sections.

### 8. Example Operational Embodiments

Embodiments of communication devices are described herein that are configured to reduce echo in audio communication signals caused by non-linearities introduced by the coupling of an external amplifier. These embodiments may perform their functions in various ways, including according to the ways described above, as well as according to the ways described in this Section. For instance, FIG. 9 shows a flowchart 900 providing a process for detecting, estimating, and compensating for non-linearities in a phone terminal, according to an exemplary embodiment. In an embodiment, phone terminal 202 of FIG. 2 may operate according to flowchart 900. Other structural and operational embodiments will be apparent to persons skilled in the relevant art(s) based on the discussion regarding flowchart 900. Flowchart 900 is described as follows.

Flowchart 900 may begin with step 902. In step 902, it is detected that an external audio amplifier has been coupled to the phone terminal. For instance, amplifier detector 204 shown in FIG. 2 may be configured to detect when external audio amplifier 220 is connected to the phone terminal 202. In some embodiments, the detection may be further accomplished using a processor(s) (e.g., processor(s) 214), circuitry and/or hardware associated with audio output interface(s) 216, and/or circuitry and/or hardware associated with audio input interface(s) 218 in addition to, or in lieu of, amplifier detector 204.

In step 904, an acoustic non-linearity introduced in a first audio signal by the external audio amplifier being coupled to the phone terminal is dynamically detected. For instance, non-linearity detector 206 shown in FIG. 2 may be configured to detect an acoustic non-linearity. In embodiments, the non-linearity may be detected based on tones or signals transmitted from audio output interface(s) 216 to external audio amplifier 220 for loudspeaker broadcast as sounds. The broadcast sounds may be received by a microphone of phone terminal 202, which translates the sounds into electrical return signals received at audio input interface(s) 218, for processing by non-linearity detector 206. As noted above, higher-order correlation/cross-correlation analyses and/or higher-order bispectrum and/or cross-bispectrum analyses may be used by non-linearity detector 206 to detect non-linearities in audio signals. In embodiments, if the higher-order analysis results in non-zero harmonic components, a detection is confirmed. In contrast, a higher-order analysis that results in zero harmonic components may be indicative of a lack of non-linear components in the audio signal. For instance, a higher-order correlation or cross-correlation analysis may be represented as a signal in one-dimension (e.g., a slice of the analysis) or two-dimensions with signal peaks at various frequencies. If the higher-order correlation or cross-correlation analysis indicates one or more correlations at a frequency other than the frequency of the signal provided to the external audio amplifier, a non-linearity may be detected at that frequency. In the case of higher-order bispectrum and/or cross-bispectrum analyses, e.g., in the frequency domain using Fourier transforms, an analysis may be represented as multi-dimensional frequency representations with non-zero values present at various frequencies. If the higher-order bispectrum and/or cross-bispectrum analyses indicate one or more frequencies other than the frequency of the signal provided to the external audio amplifier are present, non-linearities may be detected at those frequencies.

In one embodiment, Gaussian noise may be provided to an external audio amplifier and a detection of non-linearities in a return audio signal may be performed in accordance with the higher-order correlation/cross-correlation analyses and/or higher-order bispectrum and/or cross-bispectrum analyses.

In step 906, at least one non-linear parameter associated with the acoustical non-linearity is estimated in response to the detection in step 904. For instance, non-linearity estimator 208 shown in FIG. 2, as well as tuning logic 402 (which may incorporate non-linearity estimator 208) of FIGS. 4 and 5, may be configured to estimate the detected acoustic non-linearity. In embodiments, the estimation may be performed using one or more of higher-order statistical analyses for cross-correlation, cross-bispectrum, and/or other signal analyses as described herein. As noted above, higher-order correlation/cross-correlation analyses and/or higher-order bispectrum and/or cross-bispectrum analyses may be performed by non-linearity estimator 208 to estimate non-linearity parameters in audio signals. As noted above, in embodiments the higher-order bispectrum and/or cross-bispectrum analyses may perform correlation/cross-correlation data to perform Fourier transforms on signal representations. The higher-order bispectrum and/or cross-bispectrum analyses in the frequency domain may be represented as multi-dimensional frequency representations with non-zero values present at various frequencies (e.g., the provided signal frequency and/or harmonic frequencies of different orders). The one or more frequency components other than the frequency of the signal provided to the external audio amplifier are analyzed to estimate non-linear parameters, such as but not limit to, frequency values and/or their respective component magnitudes.

In one embodiment, Gaussian noise and/or a series of tones, each tone comprising at least one frequency, amplitude, or phase that is different from those of other tones, may be provided to an external audio amplifier and an estimation of non-linear parameters in the respective return audio signals may be performed in accordance with the higher-order correlation/cross-correlation analyses and/or higher-order bispectrum and/or cross-bispectrum analyses.

In step 908, the detected acoustic non-linearity in the first audio signal is compensated for, based at least upon the at least one estimated non-linear parameter, to generate an echo-cancelled audio signal. For instance, non-linearity compensator 210 shown in FIG. 2, as well as pre-distortion circuit 302 of FIGS. 3 and 4, pre-processing echo canceller 304 of FIGS. 3 and 5, post-processing echo suppressor 306 of FIG. 3, and non-linear echo suppressor 606 of FIG. 6, may be configured to compensate for the detected acoustic non-linearity based upon the estimated parameters determined in step 906. In embodiments, the compensation may include one or more of performing a linearization using a pre-distortion circuit (e.g., FIG. 4), a pre-processing non-linear echo canceller (e.g., FIG. 5), and/or using a post-processing non-linear echo canceller (e.g., FIG. 6), as described in an earlier Section herein, or as otherwise known.

In some example embodiments, one or more steps 902, 904, 906, and/or 908 of flowchart 900 may not be performed. Moreover, steps in addition to or in lieu of steps 902, 904, 906, and/or 908 may be performed. Further, in some example embodiments, one or more of steps 902, 904, 906, and/or 908 may be performed out of order, in an alternate sequence, or partially (or completely) concurrently with other steps.

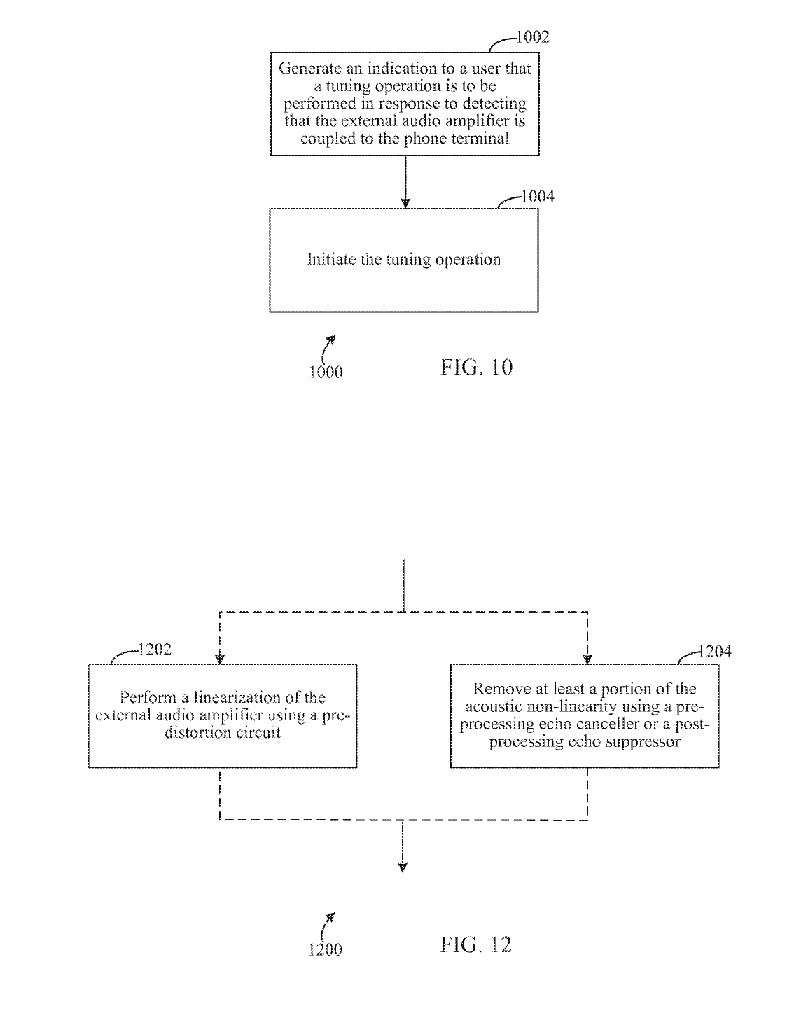

It is noted that when an external audio amplifier has been coupled to a phone terminal (step 902), which triggers an attempt to detect a non-linearity introduced in an audio signal by the external audio amplifier (step 904), this may result in sounds being broadcast from a loudspeaker associated with the external audio amplifier (e.g., tones, etc.) that are used to perform the detection. Accordingly, it may be desirable to provide notice to a user about the sounds to be broadcast. For instance, FIG. 10 shows a flowchart 1000 providing a process for indicating to a user that a tuning operation is to be performed, according to an exemplary embodiment. In some embodiments, flowchart 1000 may be performed in conjunction with, or in addition to, flowchart 900 of FIG. 9. Other structural and operational embodiments will be apparent to persons skilled in the relevant art(s) based on the discussion regarding flowchart 1000. Flowchart 1000 is described as follows.

Flowchart 1000 may begin with step 1002. In step 1002, an indication to a user that a tuning operation is to be performed is generated in response to detecting that the external audio amplifier is coupled to the phone terminal. In embodiments, amplifier detector 204 may generate the indication after detecting that an external audio amplifier 220 has been coupled to the phone terminal (e.g., phone terminal 202). The indication may be made in any form. For instance, in an embodiment, a display screen of phone terminal 202 may display a textual and/or graphical message indicating that a tuning operation will be or is being performed. Alternatively, a voice or other sound may be broadcast from a loudspeaker associated with phone terminal 202 that indicates that the tuning operation is being performed, and/or another type of indication may be made to the user. Note that in an embodiment, the user may be enabled to cancel the tuning operation if desired (e.g., by pressing a button on phone terminal 202, etc.).

In step 1004, the tuning operation is initiated. In embodiments, the tuning operation may be initiated by amplifier detector 204, processor(s) 214, and/or any components/circuits of phone terminal 202. Step 1004 may be performed during or after step 1002. Example embodiments of tuning operations are described in further detail above, as well as being described below with respect to flowchart 1100.

For example, FIG. 11 shows a flowchart 1100 providing a process for performing a tuning operation, according to an exemplary embodiment. For example, flowchart 1100 may be performed by tuning logic 402. Other structural and operational embodiments will be apparent to persons skilled in the relevant art(s) based on the discussion regarding flowchart 1100. Flowchart 1100 is described as follows.

Flowchart 1100 may begin with step 1102. In step 1102, an audio test signal is provided to the external audio amplifier to cause at least one loudspeaker coupled to the audio amplifier to broadcast sound. For instance, audio output interface(s) 216 shown in FIG. 2 may be configured to provide/transmit a signal to external audio amplifier 220 causing the at least one loudspeaker to broadcast sound. The provided audio test signal may be configured to cause the at least one loudspeaker to broadcast Gaussian noise, one or more audio tones, one or more audio tones of different frequencies, design-specific sounds, and/or the like. In some embodiments, providing the signal to external audio amplifier 220 may be performed wirelessly (e.g., by Bluetooth, IEEE 802.11, infrared (“IR”), and/or the like) or may be performed through a wired connection between the phone terminal (e.g., phone terminal 202) and external audio amplifier 220.

In step 1104, the broadcast sound is received by at least one microphone of the phone terminal. For instance, audio input interface(s) 218 shown in FIG. 2 may include one or more microphones and be configured to receive sound broadcast by one or more loudspeakers coupled to external audio amplifier 220.

In step 1106, a return signal is generated based on the received broadcast sound. For instance, audio input interface(s) 218 and/or processor(s) 214 shown in FIG. 2 may be configured to generate the return signal as a digital signal that includes a stream of numeric samples. In embodiments, the generated return signal may include non-linear acoustic components associated with the received broadcast sound, as described herein.

In step 1108, an analysis of the return signal is performed. For instance, non-linearity detector 206 and/or non-linearity estimator 208 shown in FIG. 2 may be configured to analyze the return signal. In embodiments, non-linearity detector 206 may be configured to analyze the return signal and detect one or more non-linear return signal components, and non-linearity estimator 208 may be configured to estimate parameters associated with the non-linear components.

In step 1110, the return signal is compared to the audio test signal. In some embodiments, the comparison may include determining the amount of skewness between the return signal and the provided test signal. Non-linearity detector 206 and/or non-linearity estimator 208 may be configured to perform the comparison in embodiments.

In step 1112, if the determined amount of skewness is zero, flowchart 1100 proceeds to step 1114 and the system is determined to be linear. If the skewness is non-zero, flowchart 1100 proceeds to step 1116.

In step 1116, a series of audio test signals is provided to the external audio amplifier to cause at least one loudspeaker coupled to the audio amplifier to broadcast sounds. For example, audio output interface(s) 216 shown in FIG. 2 may be configured to provide/transmit a signal in digital or analog form to external audio amplifier 220 causing the at least one loudspeaker to broadcast sound. The provided signal may cause the at least one loudspeaker to broadcast Gaussian noise, one or more audio tones, one or more audio tones of different frequencies, design-specific sounds, and/or the like. In some embodiments, providing the signal to external audio amplifier 220 may be performed wirelessly (e.g., by Bluetooth, IEEE 802.11, infrared (“IR”), and/or the like) or may be performed through a wired connection between the phone terminal (e.g., phone terminal 202) and external audio amplifier 220.

In step 1118, the broadcast sounds are received by at least one microphone of the phone terminal. For instance, audio input interface(s) 218 shown in FIG. 2 may include one or more microphones and be configured to receive sounds from one or more loudspeakers coupled to external audio amplifier 220.

In step 1120, return signals are generated based on the received broadcast sounds. For instance, audio input interface(s) 218 and/or processor(s) 214 shown in FIG. 2 may be configured to generate the return signals. In embodiments, the generated return signals may include non-linear acoustic components associated with the received broadcast sounds, as described herein.

In step 1122, an analysis of the return signals is performed. For instance, non-linearity detector 206 and/or non-linearity estimator 208 shown in FIG. 2 may be configured to analyze the return signals. In embodiments, non-linearity detector 206 may be configured to analyze the return signals and detect one or more non-linear return signal components, and non-linearity estimator 208 may be configured to estimate parameters associated with the non-linear components. For example, non-linearity detector 206 may be configured to determine cross-cumulants of the return signals and test signals, as described above.

In step 1124, a 2D-DFT is performed on the return signals. In embodiments processor(s) 214 and/or non-linearity estimator 208 of FIG. 2 may be configured to perform the two-dimensional discrete Fourier transform, as described above.

In step 1126, bispectrum points of the return signals and corresponding spectrum points of the series of audio test signals may be determined. In embodiments, these points may be determined based, at least in part, on the results of the 2D-DFT performed in step 1124. Processor(s) 214 and/or non-linearity estimator 208 of FIG. 2 may be configured to determine the bispectrum and spectrum points, as described above.

In step 1128, non-linear parameters may be estimated. For example, non-linear parameters of return signals may be estimated based, at least in part, on the determined bispectrum and spectrum points of step 1126, as described above. In embodiments, the estimation of the non-linear parameters may be performed by Processor(s) 214 and/or non-linearity estimator 208 of FIG. 2.

In some example embodiments, one or more of the steps of flowchart 1100 may not be performed. Moreover, steps in addition to or in lieu of one or more of the steps of flowchart 1100 may be performed. Further, in some example embodiments, one or more of the steps of flowchart 1100 may be performed out of order, in an alternate sequence, or partially (or completely) concurrently with other steps.

As noted above with respect to FIG. 9, the embodiments described herein may perform their functions in various ways. For example, FIG. 12 shows a flowchart 1200 providing a process for performing compensation for acoustic non-linearities, according to an exemplary embodiment. In some embodiments, flowchart 1200 may be a further embodiment of step 908 of flowchart 900, as shown in FIG. 9. Other structural and operational embodiments will be apparent to persons skilled in the relevant art(s) based on the discussion regarding flowchart 1200. Flowchart 1200 is described as follows.

Flowchart 1200 may begin with step 1202. In step 1202, a linearization of the external audio amplifier is performed using a pre-distortion circuit. For instance, pre-distortion circuit 302 of FIG. 3 may be configured to perform linearization. In embodiments, pre-distortion circuit 302 may perform the linearization in conjunction with other components of phone terminal 202, models, higher-order statistical analyses, and/or tuning operations, as described herein.

Flowchart 1200 may alternately, or simultaneously, begin with step 1204. In step 1204, at least a portion of the acoustic non-linearity is removed using a pre-processing echo canceller or a post-processing echo suppressor. For instance, pre-processing echo canceller 304 and/or post-processing echo suppressor 306 of FIG. 3 may be configured to remove at least a portion of the non-linearity. In embodiments, pre-processing echo canceller 304 and/or post-processing echo suppressor 306 may be present to remove acoustic non-linearities in conjunction with other components of phone terminal 202, models, higher-order statistical analyses, and/or tuning operations, as described herein.

### 9. Example Computer Embodiments

Phone terminal system 200, phone terminal 202, amplifier detector 204, non-linearity detector 206, non-linearity estimator 208, non-linearity compensator 210, linear canceller filter 212, one or more processors 214, one or more audio output interface(s) 216, one or more audio input interface(s) 218, external audio amplifier 220, pre-distortion circuit 302, pre-processing echo canceller 304, post-processing echo suppressor 306, pre-distortion circuit echo canceller system 400, tuning logic 402, pre-processing echo canceller system 500, adaptation logic 502, post-processing echo suppressor system 600, first analysis bank 602, SRER estimator 604, non-linear echo suppressor 606, non-linear frequency model 608, second analysis bank 610, synthesis bank 612, memoryless non-linearity model 700, non-linearity memory model 800, any of their components or sub-components, and/or any further systems, sub-systems, and/or components disclosed herein may be implemented in hardware (e.g., hardware logic/electrical circuitry), or any combination of hardware with software (computer program code or instructions configured to be executed in one or more processors or processing devices) and/or firmware. Such embodiments may be commensurate with the description in this Section.

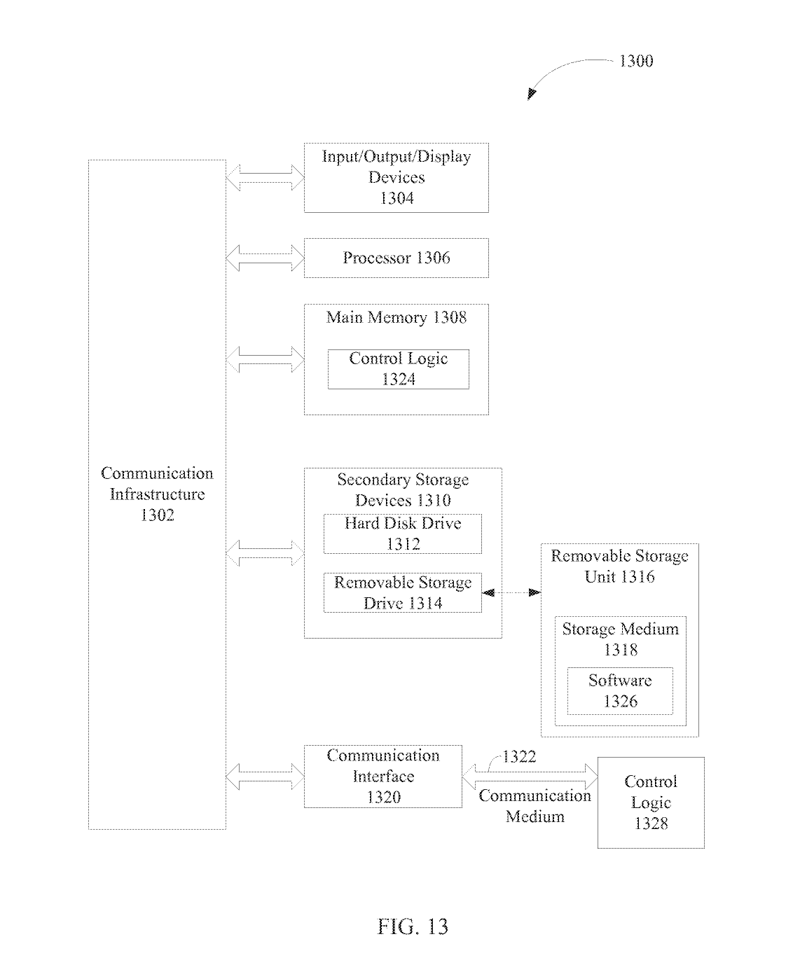

The embodiments described herein, including systems, methods/processes, and/or apparatuses, may be implemented using well known processing devices, telephones (land line based telephones, conference phone terminals, smart phones and/or mobile phones), interactive television, servers, and/or, computers, such as a computer 1300 shown in FIG. 13. It should be noted that computer 1300 may represent communication devices (e.g., phone terminals), processing devices, and/or traditional computers in one or more embodiments. For example, phone terminal 202, and any of the sub-systems, components, and/or models respectively contained therein and/or associated therewith, may be implemented using one or more computers 1300.

Computer 1300 can be any commercially available and well known communication device, processing device, and/or computer capable of performing the functions described herein, such as devices/computers available from International Business Machines®, Apple®, Sun®, HP®, Dell®, Cray®, Samsung®, Nokia®, etc. Computer 1300 may be any type of computer, including a desktop computer, a server, etc.

Computer 1300 includes one or more processors (also called central processing units, or CPUs), such as a processor 1306. Processor 1306 is connected to a communication infrastructure 1302, such as a communication bus. In some embodiments, processor 1306 can simultaneously operate multiple computing threads.

Computer 1300 also includes a primary or main memory 1308, such as random access memory (RAM). Main memory 1308 has stored therein control logic 1324 (computer software), and data.

Computer 1300 also includes one or more secondary storage devices 1310. Secondary storage devices 1310 include, for example, a hard disk drive 1312 and/or a removable storage device or drive 1314, as well as other types of storage devices, such as memory cards and memory sticks. For instance, computer 1300 may include an industry standard interface, such a universal serial bus (USB) interface for interfacing with devices such as a memory stick. Removable storage drive 1314 represents a floppy disk drive, a magnetic tape drive, a compact disk drive, an optical storage device, tape backup, etc.

Removable storage drive 1314 interacts with a removable storage unit 1316. Removable storage unit 1316 includes a computer useable or readable storage medium 1318 having stored therein computer software 1326 (control logic) and/or data. Removable storage unit 1316 represents a floppy disk, magnetic tape, compact disk, DVD, optical storage disk, or any other computer data storage device. Removable storage drive 1314 reads from and/or writes to removable storage unit 1316 in a well-known manner.

Computer 1300 also includes input/output/display devices 1304, such as touchscreens, LED and LCD displays, monitors, keyboards, pointing devices, etc.

Computer 1300 further includes a communication or network interface 1318. Communication interface 1320 enables computer 1300 to communicate with remote devices. For example, communication interface 1320 allows computer 1300 to communicate over communication networks or mediums 1322 (representing a form of a computer useable or readable medium), such as LANs, WANs, the Internet, etc. Network interface 1320 may interface with remote sites or networks via wired or wireless connections.

Control logic 1328 may be transmitted to and from computer 1300 via the communication medium 1322.

Any apparatus or manufacture comprising a computer useable or readable medium having control logic (software) stored therein is referred to herein as a computer program product or program storage device. This includes, but is not limited to, computer 1300, main memory 1308, secondary storage devices 1310, and removable storage unit 1316. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic to implement, for example, amplifier detector 204, non-linearity detector 206, non-linearity estimator 208, non-linearity compensator 210, linear canceller filter 212, pre-distortion circuit 302, pre-processing echo canceller 304, post-processing echo suppressor 306, pre-distortion circuit echo canceller system 400, tuning logic 402, pre-processing echo canceller system 500, adaptation logic 502, post-processing echo suppressor system 600, first analysis bank 602, SRER estimator 604, non-linear echo suppressor 606, non-linear frequency model 608, second analysis bank 610, synthesis bank 612, memoryless non-linearity model 700, non-linearity memory model 800, and/or further embodiments described herein. Embodiments of the invention are directed to computer program products comprising such logic (e.g., in the form of program code or instructions) stored on any computer useable medium. Such program code, when executed in one or more processors, causes a device to operate as described herein.

Note that such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

### 10. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A method in a phone terminal for performing acoustic echo cancellation for telephony systems configured to connect to external amplifiers or speakers, comprising:
detecting that an external audio amplifier has been coupled to the phone terminal;
dynamically detecting an acoustic non-linearity introduced in a first audio signal by the external audio amplifier being coupled to the phone terminal;
estimating at least one non-linear parameter associated with the acoustical non-linearity in response to the detection; and
compensating for the detected acoustic non-linearity in the first audio signal based at least upon the at least one estimated non-linear parameter to generate an echo-cancelled audio signal.

2. The method of claim 1, further comprising:
generating an indication to a user that a tuning operation is to be performed in response to detecting that the external audio amplifier is coupled to the phone terminal; and
initiating the tuning operation.

3. The method of claim 1, wherein compensating comprises at least one of:
performing a linearization of the external audio amplifier using a pre-distortion circuit, or
removing at least a portion of the acoustic non-linearity using a pre-processing echo canceller.

4. The method of claim 1, further comprising:
providing an audio test signal to the external audio amplifier to cause at least one loudspeaker coupled to the audio amplifier to broadcast sound;
receiving the broadcast sound by at least one microphone of the phone terminal;
generating a return signal based on the received broadcast sound; and
performing an analysis of the return signal.

5. The method of claim 4, wherein said performing an analysis of the return signal comprises:
performing at least one of
a third-order statistical cross-correlation analysis between the audio test signal and the return signal to generate a third-order cross-correlation,
a third-order statistical cross-bispectrum analysis between the audio test signal and the return signal to generate a third-order cross-bispectrum, or
an additional third-order statistical analysis between the audio test signal and the return signal.

6. The method of claim 5, wherein said providing an audio test signal to the external audio amplifier to cause at least one loudspeaker coupled to the audio amplifier to broadcast sound comprises:
providing a Gaussian signal as the test signal; and
wherein said dynamically detecting further comprises:
detecting the acoustic non-linearity by analyzing the third-order cross-correlation and the third-order cross-bispectrum.

7. The method of claim 5, wherein said providing an audio test signal to the external audio amplifier to cause at least one loudspeaker coupled to the audio amplifier to broadcast sound comprises:
providing a series of tones, each tone comprising at least one frequency, amplitude, or phases that is different from each other tone, as the test signal; and
wherein said estimating further comprises:
estimating the at least one non-linear parameter by analyzing the third-order cross-correlation and the third-order cross-bispectrum at a plurality of frequencies.

8. The method of claim 4, further comprising at least one of:
estimating a bulk delay associated with the phone terminal and the coupled external audio amplifier;
estimating an energy imbalance between a left audio channel and a right audio channel; or
adding one or more TAPs to reduce an algorithmic delay associated with one or more of said dynamically detecting, said estimating, or said compensating.

9. The method of claim 1, wherein at least one of said dynamically detecting, said estimating, or said compensating is performed in accordance with a memoryless non-linearity associated with one or more of at least one small loudspeaker and at least one memoryless analog device, or a memory-based non-linearity associated with one or more of at least one large loudspeaker and at least one memory-based analog device.

10. A phone terminal, comprising:
an amplifier detector configured to detect that an external audio amplifier has been coupled to the phone terminal;
a non-linearity detector configured to dynamically detect an acoustic non-linearity introduced in a first audio signal by the external audio amplifier being coupled to the phone terminal;
a non-linearity estimator configured to estimate at least one non-linear parameter associated with the acoustical non-linearity in response to the detection; and
a non-linearity compensator configured to compensate for the detected acoustic non-linearity in the first audio signal based at least upon the at least one estimated non-linear parameter to generate an echo-cancelled audio signal.

11. The phone terminal of claim 10, wherein the amplifier detector is further configured to:
generate an indication to a user that a tuning operation is to be performed in response to detecting that the external audio amplifier is coupled to the phone terminal; and
wherein the phone terminal further comprises:
one or more processors configured to initiate a tuning operation.

12. The phone terminal of claim 10, wherein the non-linearity compensator comprises at least one of:
a pre-distortion circuit configured to perform a linearization of the external audio amplifier, or
a pre-processing echo canceller configured to remove the acoustic non-linearity.

13. The phone terminal of claim 12, further comprising:
an audio output device configured to provide an audio test signal to the external audio amplifier to cause at least one loudspeaker coupled to the audio amplifier to broadcast sound;
at least one microphone configured to receive the broadcast sound by at least one microphone of the phone terminal; and
one or more processors configured to generate a return signal based on the received broadcast sound;
wherein at least one of the non-linearity detector or the non-linearity estimator is configured to perform an analysis of the return signal.

14. The phone terminal of claim 13, wherein at least one of the non-linearity detector or the non-linearity estimator is configured to perform the analysis of the return signal by performing at least one of:
a third-order statistical cross-correlation analysis between the audio test signal and the return signal to generate a third-order cross-correlation,
a third-order statistical cross-bispectrum analysis between the audio test signal and the return signal to generate a third-order cross-bispectrum, or
an additional third-order statistical analysis between the audio test signal and the return signal.

15. The phone terminal of claim 14, wherein the audio output device is further configured to:
provide a Gaussian signal as the test signal; and
wherein the non-linearity detector is further configured to:
detect the acoustic non-linearity by analyzing the third-order cross-correlation and the third-order cross-bispectrum.

16. The phone terminal of claim 14, wherein the audio output device is further configured to:
provide a series of tones with different frequencies as the test signal; and
wherein the non-linearity estimator is further configured to:
estimate the at least one non-linear parameter by analyzing the third-order cross-correlation and the third-order cross-bispectrum at a plurality of frequencies.

17. The phone terminal of claim 13, wherein at least one of the one or more processors is configured to perform at least one of:
implement at least one signal filter that includes one or more TAPs to reduce an algorithmic delay;
estimate a bulk delay associated with the phone terminal and the coupled external audio amplifier, or
estimate an energy imbalance between a left audio channel and a right audio channel.

18. The phone terminal of claim 10, wherein at least one of the non-linearity detector, the non-linearity estimator or the non-linearity compensator is configured to operate in accordance with a memoryless non-linearity associated with one or more of at least one small loudspeaker and at least one memoryless analog device, or a memory-based non-linearity associated with one or more of at least one large loudspeaker and at least one memory-based analog device.

19. A computer-readable storage medium having computer-executable instructions recorded thereon for causing a processing device of a phone terminal to execute a method for performing acoustic echo cancellation, the method comprising:
detecting that an external audio amplifier has been coupled to the phone terminal;
dynamically detecting an acoustic non-linearity introduced in a first audio signal by the external audio amplifier being coupled to the phone terminal;
estimating at least one non-linear parameter associated with the acoustical non-linearity in response to the detection; and
compensating for the detected acoustic non-linearity in the first audio signal based at least upon the at least one estimated non-linear parameter to generate an echo-cancelled audio signal.

20. The computer-readable storage device of claim 19, the method further comprising:
generating an indication to a user that a tuning operation is to be performed in response to detecting that the external audio amplifier is coupled to the phone terminal;
providing an audio test signal to the external audio amplifier to cause at least one loudspeaker coupled to the audio amplifier to broadcast sound;
receiving the broadcast sound by at least one microphone of the phone terminal;
generating a return signal based on the received broadcast sound; and
performing an analysis of the return signal, comprising at least one of:
a third-order statistical cross-correlation analysis between the audio test signal and the return signal to generate a third-order cross-correlation, or
a third-order statistical cross-bispectrum analysis between the audio test signal and the return signal to generate a third-order cross-bispectrum.
